(19) United States
(12) Patent Application Publication
(10) Pub. No.: US 2015/0356117 A1
(43) Pub. Date: Dec. 10, 2015

(54) EVENTUAL CONSISTENCY TO RESOLVE SUBSCRIBER SHARING RELATIONSHIPS IN A DISTRIBUTED SYSTEM

(71) Applicant: Oracle International Corporation, Redwood Shores, CA (US)

(72) Inventors: Jens Kaemmerer, Pacific Grove, CA (US); Balaji Nagamangala Rajan, Bangalore (IN)

(21) Appl. No.: 14/688,503

(22) Filed: Apr. 16, 2015

Related U.S. Application Data
(60) Provisional application No. 62/009,861, filed on Jun. 9, 2014.

(51) Int. Cl. G06F 17/30

(52) U.S. Cl. CPC G06F 17/30227; G06F 17/30194

(57) ABSTRACT

A method is disclosed. The method comprises executing a transaction on a number of distributed objects. The distributed objects are maintained on a number of computing entities, and a distributed relationship exists between the objects. The executing the transaction includes performing a preparation operation, performing a processing operation, and performing a post-processing operation.

### CROSS-REFERENCE TO RELATED APPLICATIONS

The present patent application claims priority to Provisional Patent Application Ser. No. 62/009,861, filed Jun. 9, 2014, and entitled “Eventual Consistency to Resolve Subscriber Sharing Relationships in a Distributed System,” which is hereby incorporated by reference herein, in its entirety and for all purposes.

### FIELD OF THE INVENTION

The present disclosure relates to transaction processing systems, and more particularly, to performing transactions using eventual consistency.

### BACKGROUND OF THE INVENTION

As information systems have become increasingly important in the business, academic and personal computing arenas, improved mechanisms for quickly and efficiently processing data handled thereby have also become increasingly important. As will be appreciated, data storage and processing constructs can become large, and so, ponderous, making the fast and efficient processing of such data difficult to effect in a timely manner. This can lead to untoward effects on an organization's ability to provide services in a timely fashion, and to respond to changes in the marketplace with the requisite speed.

For example, service providers are experiencing ever-growing service usage by subscribers. A service provider in the telecommunications arena can provide the requisite services, in part, by implementing a charging and billing system (or more simply, a charging system), in which subscribers are charged for their service usage. For example, a charging system in a cellular telephony system may implement a policy and charging control solution, such as that developed under 3GPP™ (3^{rd} Generation Partnership Project) IMS (Internet Multimedia Subsystems), among other such approaches that support various charging systems and the business models such systems embody.

In some cases, services may be offered to a group of users or other such entities. Service providers often offer services to groups of one or more subscribers, allowing such services to be shared between the subscribers of one or more such groups. Charging and billing systems limit sharing relationships to subscribers co-located in a single partition. Only subscribers local to the processing performed can be added to an existing sharing relations easily. Non-local subscribers, by contrast, need to be migrated prior to such processing (which involves a complex distributed transaction). However, migrating subscriber data impacts availability of the subscriber significantly. Restrictions as to the creation of sharing relationships can thus create operational obstacles. Moreover, migrating subscribers can lead to unbalanced partitions (in an extreme case, all subscribers could end up migrated onto a single system, problematic for a number of reasons, including reduced performance and greater exposure to failure).

Alternatively, such charging and billing systems could leverage distributed transaction support built into certain systems (e.g., some database systems provide such functionality), in order to effect transactions involving sharing relationships. However, maintaining strict consistency (Atomicity, Consistency, Isolation, Durability (ACID) properties) in a distributed system is associated with a very high computational and communications cost. Increasing use of sharing relationships leads to a ‘superlinear’ increase in total cost of ownership (TCO) for a provider (e.g., network operator). Thus, while such distributed transactions are simpler and easier to use from a programmatic perspective, the scalability of such approaches quickly becomes problematic, as the number of subscribers/transactions increases, due to the significant computational, bandwidth, and storage overhead involved with each such distributed transaction. As will also be appreciated, the dynamic nature of such sharing relationships, particularly where a subscriber may be a member of multiple such relationships and those relationships can change over time, only complicates the problems encountered (e.g., further increasing the demand for resources and the resulting latency experience).

Thus, in view of the foregoing, it would be desirable to provide the ability to provide for operations that are able to accomplish the results of a distributed transaction without the substantial overhead involved therein, without the need for such infrastructure, and to avoid the attendant problems therewith.

### BRIEF DESCRIPTION OF THE DRAWINGS

The present invention may be better understood, and its numerous objects, features and advantages made apparent to those skilled in the art by referencing the accompanying drawings.

FIG. 1 is a simplified block diagram illustrating an example of a computing environment in which distributed objects can be processed according to embodiments of the methods and systems disclosed herein.

FIG. 2 is a simplified flow diagram illustrating an example of the operations performed in effecting a transaction on objects in a distributed relationship, according to embodiments of the methods and systems disclosed herein.

FIG. 3 is a simplified block diagram illustrating an example of a network architecture that includes a charging system according to embodiments of the methods and systems disclosed herein.

FIG. 4 is a simplified block diagram illustrating an example of a network architecture, according to embodiments of the methods and systems disclosed herein.

FIG. 5A is a simplified block diagram illustrating an example of a charging architecture, according to embodiments of the methods and systems disclosed herein.

FIG. 5B is a simplified block diagram illustrating components of an example communications architecture, according to embodiments of the methods and systems disclosed herein.

FIG. 6 is a simplified block diagram illustrating an example of a charging engine architecture in which subscriber objects and events can be processed according to embodiments of the methods and systems disclosed herein.

FIG. 7 is a simplified block diagram illustrating an example of charging system objects, according to embodiments of the methods and systems disclosed herein.

FIG. 8 is a simplified flow diagram illustrating an example of the operations performed in effecting a transaction on subscriber objects in a sharing relationship, according to embodiments of the methods and systems disclosed herein.

FIGS. 9A, 9B, 9C, and 9D (referred to hereinafter as FIG. 9) represent a simplified flow diagram illustrating an example of a three object processor approach, according to embodiments of the methods and systems disclosed herein.

FIG. 10 is a simplified flow diagram illustrating an example of a retry activity sequence, according to embodiments of the methods and systems disclosed herein.

FIGS. 11A, 11B, and 11C (referred to hereinafter as FIG. 11) represent a simplified sequence diagram illustrating an example of a usage transaction sequence, according to embodiments of the methods and systems disclosed herein.

FIGS. 12A and 12B (referred to hereinafter as FIG. 12) represent a simplified sequence diagram illustrating an example of a duplicate check transaction sequence, according to embodiments of the methods and systems disclosed herein.

FIGS. 13A and 13B (referred to hereinafter as FIG. 13) represent a simplified sequence diagram illustrating an example of a duplicate check transaction sequence, according to embodiments of the methods and systems disclosed herein.

FIG. 14 is a simplified sequence diagram illustrating an example of a sharing transaction sequence, according to embodiments of the methods and systems disclosed herein.

FIGS. 15A and 15B (referred to hereinafter as FIG. 15) represent a simplified sequence diagram illustrating an example of a save sharing customer state activity transaction sequence, according to embodiments of the methods and systems disclosed herein.

FIG. 16 is a block diagram depicting a computer system suitable for implementing aspects of systems according to embodiments of systems such as those disclosed herein.

FIG. 17 is a block diagram depicting a network architecture suitable for implementing aspects of systems according to embodiments of systems such as those disclosed herein.

### DETAILED DESCRIPTION

The following is intended to provide a detailed description of an example of the invention and should not be taken to be limiting of the invention itself. Rather, any number of variations may fall within the scope of the invention which is defined in the claims following the description.

### Introduction

Fundamentally, in light of the aforementioned problems, embodiments such as those described herein employ a three-operation process to execute the desired transaction on a number of distributed objects, where the distributed objects (e.g., variables, data structures, functions, instantiated classes, and/or other such programmatic constructs) are maintained on two or more computing entities and are in one or more distributed relationships with one another. Such approaches thus provide the ability to perform such operations on multiple objects, such as might be encountered in when operation on objects in a sharing relationship with one another, as where such objects represent subscribers in sharing relationship groups. Methods and systems such as those described herein accomplish these ends by, effectively, decomposing a transaction involving a sharing relationship into a series of smaller, idempotent operations (operations that can be applied multiple times without changing the result beyond the initial application. To perform a transaction involving a distributed relationship (e.g., a sharing relationship between service subscribers), the three operations include: a preparation operation (in which the requisite data is reserved (locked) and a copy thereof transported to a single (logical and/or physical) location); processing (in which processing involving the data involved in the sharing relationship takes place); and post-processing (in which changes are made to the data of the distributed participants (e.g., the objects representing participating subscribers), reservations (locks) released, and garbage collection performed). These operations are discussed in greater detail subsequently.

In so doing, embodiments such as those described herein allow transactions to be performed based on eventual consistency, and thereby resolve updates and other changes resulting from transactions involving subscriber sharing relationships (and so, data from multiple subscribers). In certain embodiments, subscriber data belonging to different subscribers may be located in different computing entities (e.g., partitions), which may be (and often are) distributed across some number of computing entities (e.g., computing nodes of, for example, an in-memory data grid (or more simply, datagrid)). Methods and systems such as those disclosed herein allow the formation of sharing relationships across the entire subscriber base or portions thereof, regardless of where the subscriber data is located (e.g., regardless of the maintenance of such data in different processes (e.g., Java™ applications and the like), virtual machines (VMs), processing nodes, and/or other such computing and/or storage entities). Such methods and systems significantly lower computational, communication, storage, and other resource costs associated with conventional distributed transactions (e.g., by a factor of as much a four or better). Thus, methods and systems according to the examples presented herein are able to effect distributed transactions based on eventual consistency to resolve subscriber sharing relationships involving data associated with multiple subscribers (e.g., subscriber data that is located in different partitions, distributed across datagrid nodes, and/or otherwise distributed). To do so, sharing relationships can be formed across an entire subscriber base, without regard to where the subscriber data is located.

As noted earlier, distributed transaction support built into some database and datagrid systems can be leveraged to provide comparable results, but such distributed transactions are computationally expensive and, in relative terms, unacceptably slow, making scalability an issue (e.g., the greater the number of sharing groups and/or subscribers in sharing groups, the worse the performance). Further, such an approach typically involves some amount of overhead in order to avoid the potential corruption of data, in the case of failures (e.g., a failure in the middle of a distributed transaction requires that the effects of the operation be nullified, for example, by way of backing out the operations performed, results discarded, and/or other such actions, but in any event, such that the system is not left in an indeterminate state). Alternatively, data objects can be migrated from one computing entity to another, in order to allow the relevant transactions to be local, in the manner noted earlier. Unfortunately, as also noted earlier, moving data objects in such a manner also comes only at great computational cost. Further, from a logical perspective, as the number of such sharing relationships increases, so to does the probability of a given subscriber belonging to multiple such sharing relationships. As will be appreciated, as more and more objects (e.g., representing subscribers) belong to such relationships, an increasingly large number of such objects will need to be migrated to a given computing entity (e.g., partition). In addition to the significant computation load represented by such a situation, another untoward result will likely be the migration of a large number of data objects to a single computing entity, which is clearly undesirable (particularly in view of the typical efforts expended in a distributed computing system to ensure a relatively even distribution of such data objects, and so computational and storage resource requirements as between computing entities thereof). The dynamic nature of such relationships only compounds the problem.

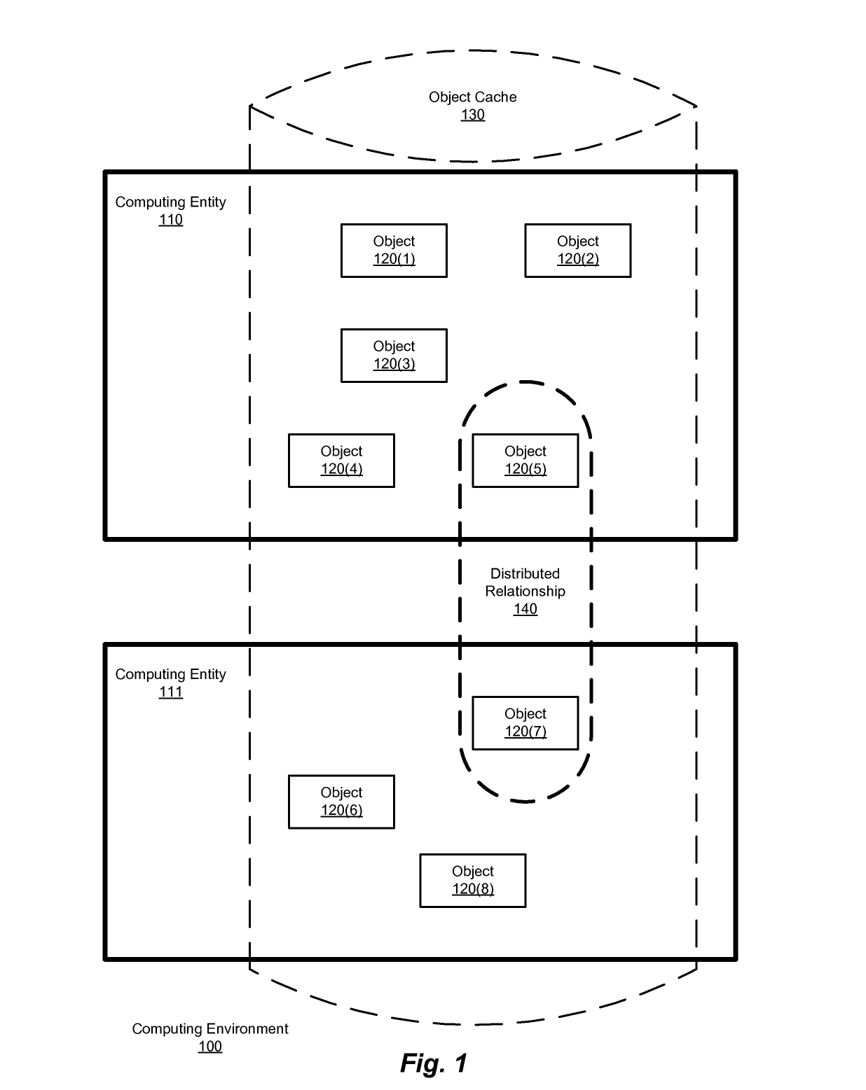

FIG. 1 is a simplified block diagram illustrating an example of a computing environment 100, in which distributed objects can be processed according to embodiments of the methods and systems disclosed herein. Computing environment 100 includes a number of computing entities (depicted, as examples, in FIG. 1 as computing entities 110 and 111). Computing entities 110 and 111 can be implemented, for example, by way of processes (one or more types of application, processing nodes, and/or other such computing and/or storage entities).

Across computing entities 110 and 111 are distributed a number of data objects (depicted, as examples, in FIG. 1 as objects 120(1)-(8)). Objects such as objects 120(1)-(8) can be used to represent, for example, the users of a given service. As depicted in FIG. 1, objects 120(1)-(8) are treated as being logically related to one another (though not necessarily in a distributed relationship) through the use of a logical construct referred to herein as an object cache (and depicted in FIG. 1, by way of example, as an object cache 130). Such a construct can, and typically is, maintained in the memory of the computing entity in question, in order to improve performance. Comparable constructs in a database environment include database tables, and, as will be appreciated in light of the present disclosure, methods and systems such as those described herein can be employed to good effect in those and other such environments.

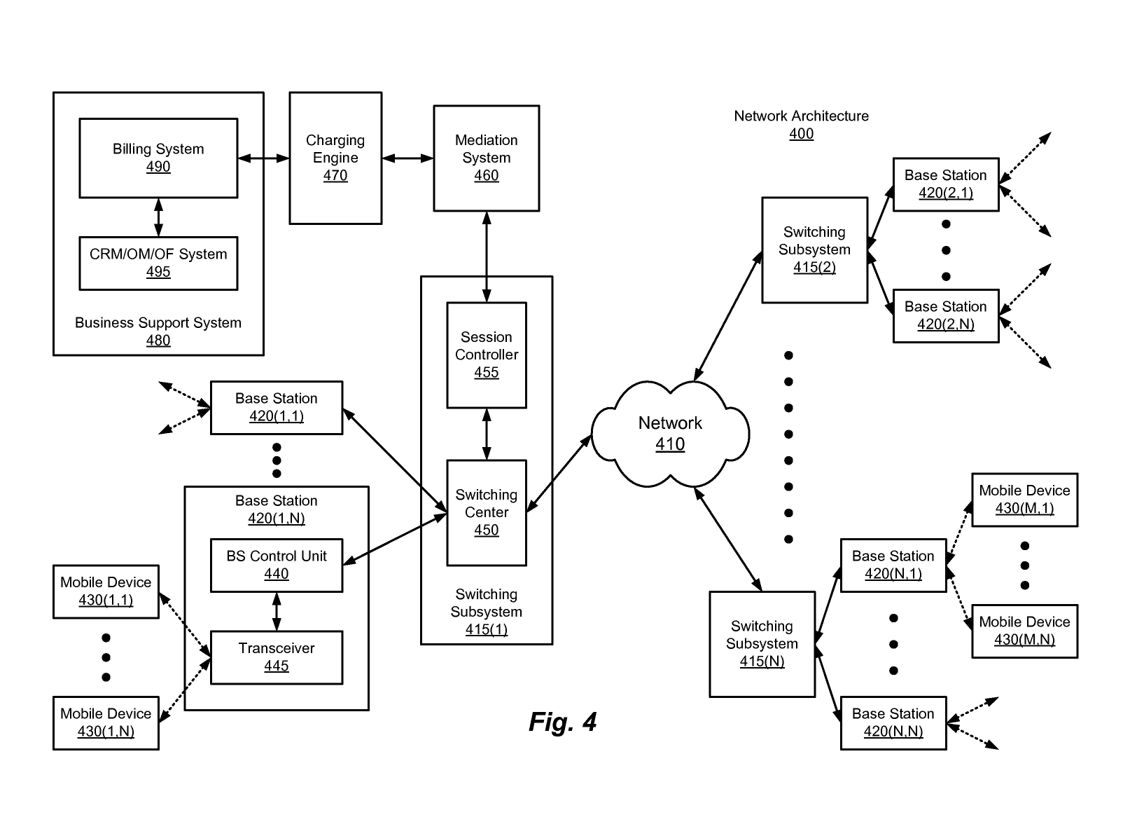

As will also be appreciated in light of the present disclosure, transactions performed on multiple ones of objects 120(1)-(8) (e.g., as a result of such objects being in distributed relationships) can encounter problems such as those described earlier (e.g., that involve migration of such objects, or making modification of the information maintained thereby in a distributed fashion). For example, objects 120(5) and 120(7) are illustrated as being in a distributed relationship with one another (depicted in FIG. 1, by way of example, as a distributed relationship 140). A transaction such as might be performed against the objects in distributed relationship 140 (objects 120(5) and 120(7)) would thus encounter the challenges described earlier, were such a transaction to employ either migration or a distributed transaction. However, by performing operations in the manner described herein, such a transaction can be effected without encountering such untoward effects, while maintaining an acceptable level of performance (e.g., as proscribed by standards and provided by infrastructure such as that described subsequently in connection with FIG. 4).

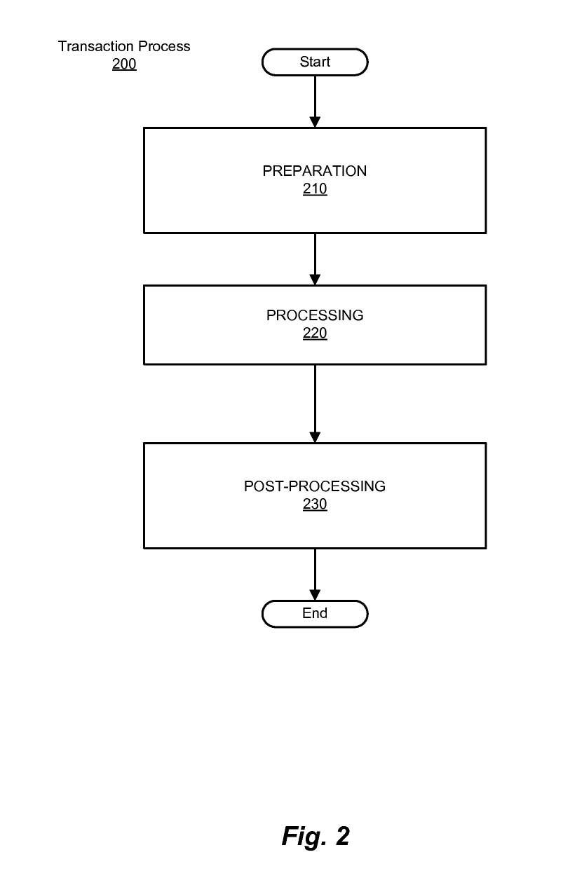

FIG. 2 is a simplified flow diagram illustrating an example of the operations performed in effecting a transaction process 200 on objects in a distributed relationship, according to embodiments of the methods and systems disclosed herein. Embodiments, such as the methods and systems described herein, decompose a transaction involving a distributed relationship into a series of smaller, idempotent operations, as is depicted in FIG. 2 and described further in connection therewith.

These three operations are performed in processing a transaction involving objects (e.g., objects 120(5) and 120(7)) in a distributed relationship (e.g., distributed relationship 140):

Operation 210: PREPARATION
reserve requisite data in objects' data
copy reserved data
transport copies of reserved data to primary computing entity

Operation 220: PROCESSING
Process data from primary object and copies of data from secondary object
Capture results of processing

Operation 230: POST-PROCESSING
Commit results of processing to primary object
Transport results of processing to other objects and commit thereto
Perform garbage collection

It should be appreciated that the reservation operation(s) noted above can reserve a given object's data in its entirety, or only a portion thereof, and that such reservations can be varied from object-to-object (e.g., subscriber account-to-subscriber account), even within the same sharing group. In certain embodiments, each transaction is associated with a unique key (e.g., a session identifier, an identifier generated from information regarding the subscribers and/or the sharing group, or the like). Successful change of an object's state through a processing operation can thus result in a record of the fact that this operation was completed successfully. This record can be associated with the transaction key. Subsequent retries of the same processing operation check the record to ensure that the same subscriber state change has not been performed twice. Alternatively, if the information being written to the given object will overwrite the information in the object's data, simply proceeding with rewriting such data offers idempotency, as either such data has not yet been written (and so needs to be written) or has already been written (but overwriting such data with the same information has no cumulative effect). That said, such an approach could ultimately prove redundant, and so repeated performance thereof, somewhat inefficient. However, given that failures necessitating such operations would be expected to be infrequent, such inefficiencies would likely be of minimal effect. In any case, it will be appreciated that an approach in which an event is sent to its relevant data can be advantageous (e.g., simplifying the handling of such events), but problematic when the data in question is distributed (e.g., as between multiple objects that are themselves distributed among computing entities). It is the problems created by such distributed data that methods and systems such as those described herein can be used to address.

Advantages of methods and systems such as those disclosed herein are many, and include:
Shifting transaction orchestration into the application layer, by tasking one or more modules in the application layer with the responsibilities of marshalling the requisite data, effecting the requested transaction, and dispersing the results thereof (e.g., rather than relying on distributed transaction functionality of a database system)
Leverage application-specific information to implement the aforementioned transaction orchestration
Relaxing atomicity and consistency transaction properties while still maintaining correctness
A combination of eventual consistency and high-performance local transactions
Significant improvement in performance over other potential alternatives

### Example Architectures

As noted, an approach according to the methods and systems described herein decomposes a transaction to be performed on some number of distributed objects (objects distributed between two or more computing entities) in a distributed relationship into three operations (preparation, processing, and post-processing). Thus, in certain embodiments, methods and systems such as those described herein decompose a transaction involving a sharing relationship among service subscribers into a series of smaller, idempotent operations.

For example, using a service subscriber scenario as an example, the three aforementioned operations can be performed in processing a transaction involving a sharing relationship between subscribers of such services (e.g., a mobile communications service provider), using an approach such as:
Operation 1: PREPARATION: Reserve and gather subscriber data
Operation 2: PROCESSING: Perform usage processing
Operation 3: POST-PROCESSING: Perform updates

As can be seen, such operations cause the entries involved to eventually become consistent, though after only the second operation, such is not the case (the changes having yet to be committed). The eventual consistency thus provided is the case even in the face of failures, with such approaches thereby offering the advantage of being fault tolerant. In processes such as those just described, failures can occur at various points. Such failures can take the form of hardware failures, power outages, software bugs, and/or any number of other failure sources, and can occur at a point in time.

Thus, in the three operation approach presented above, there can be three points of failure (caused, e.g., by hardware failures, software failures, and the like). Using the example above:
Between PREPARATION and PROCESSING
Between PROCESSING and POST-PROCESSING
After POST-PROCESSING

In each case, because sufficient information remains available and the operations are idempotent, such failures are recoverable, and in a fast, efficient manner. These failure modes will be discussed later, in connection with the examples described subsequently.

The performance provided by methods and systems such as those described herein are made possible, at least in part, by the nature of the operations performed. Instead of a distributed transaction (with its attendant poor performance), techniques such as those described herein decompose such transactions into (what are referred to herein as) “local transactions,” which are faster and more efficient, due in part to the fact that such local transactions operate only on objects (e.g., subscriber objects and events) that are local to the given computing entity.

Using a subscriber sharing agreement in a communications architecture, in which subscribers avail themselves of mobile communications services provided by a communications service provider, as an example, the following figures and their corresponding descriptions provide relevant examples that provide a context for operations such as those discussed above. As will be appreciated in light of the present disclosure, such figures and descriptions are merely examples, presented simply to allow for further discussion of the features of such methods and systems. Embodiments according to methods and systems such as those described herein find application in a wide variety of scenarios, in which distributed objects are subject to a transaction involving a distributed relationship (as between ones of those distributed objects).

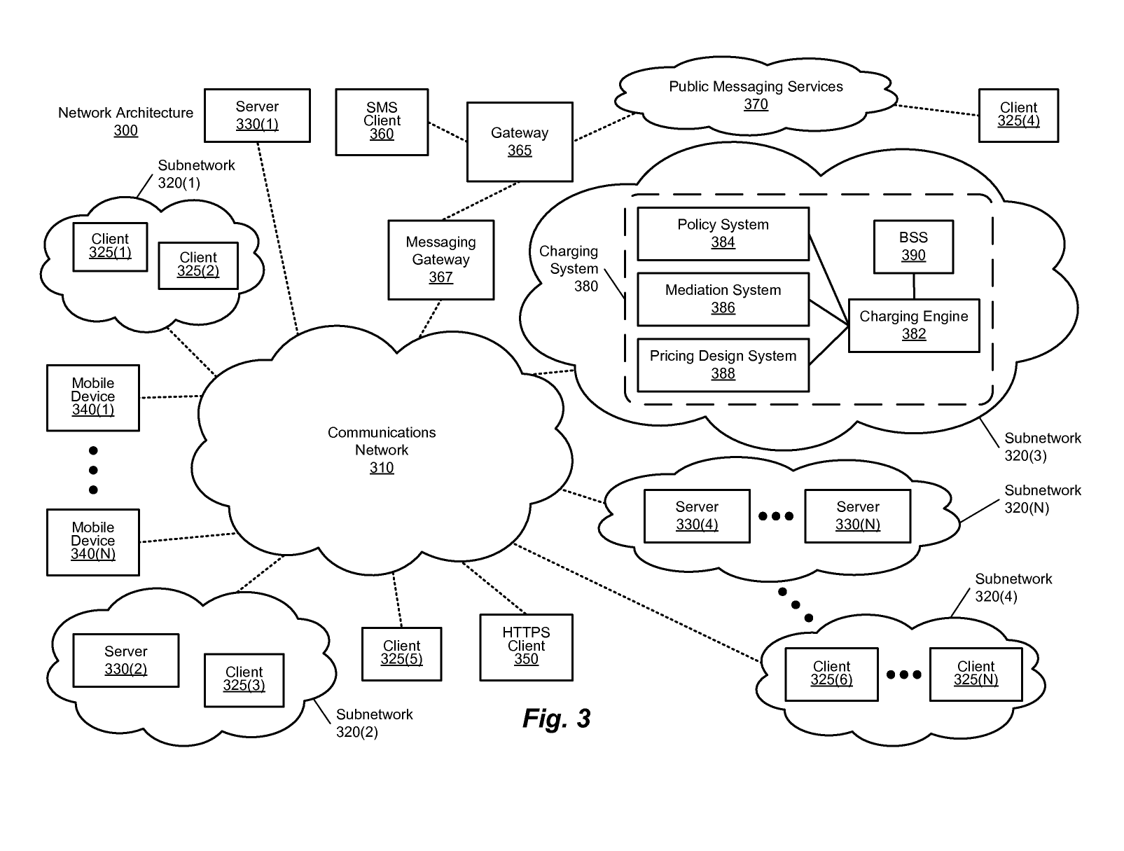

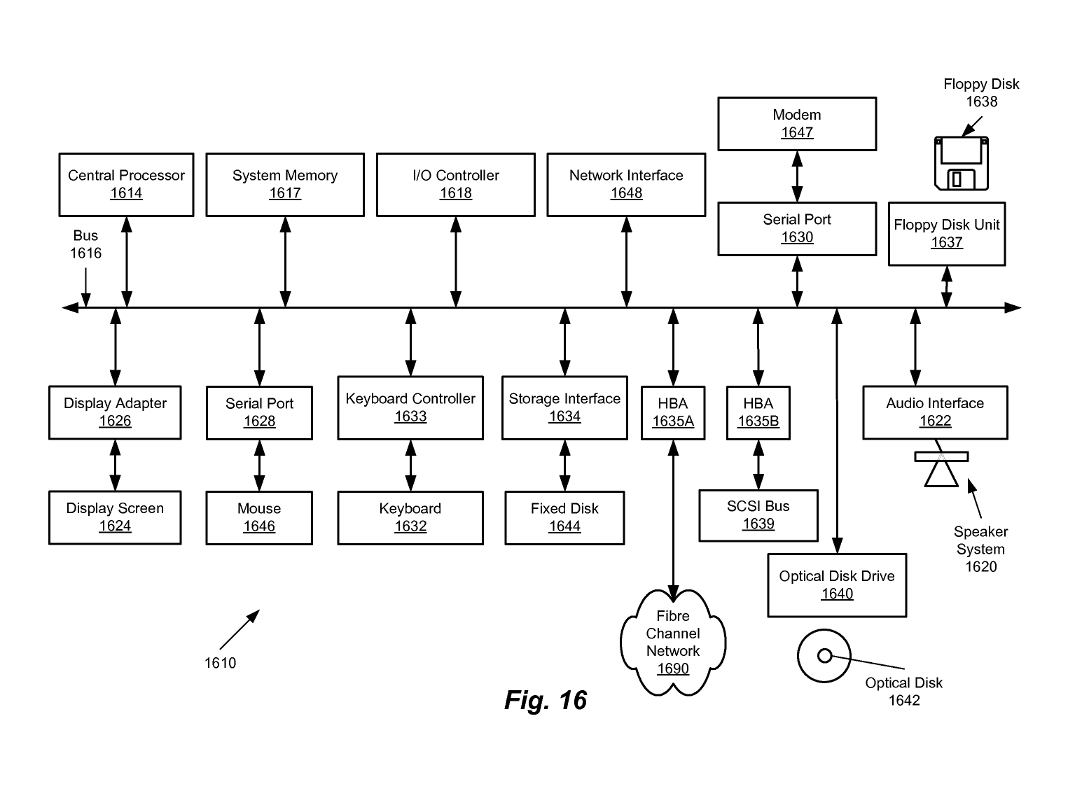

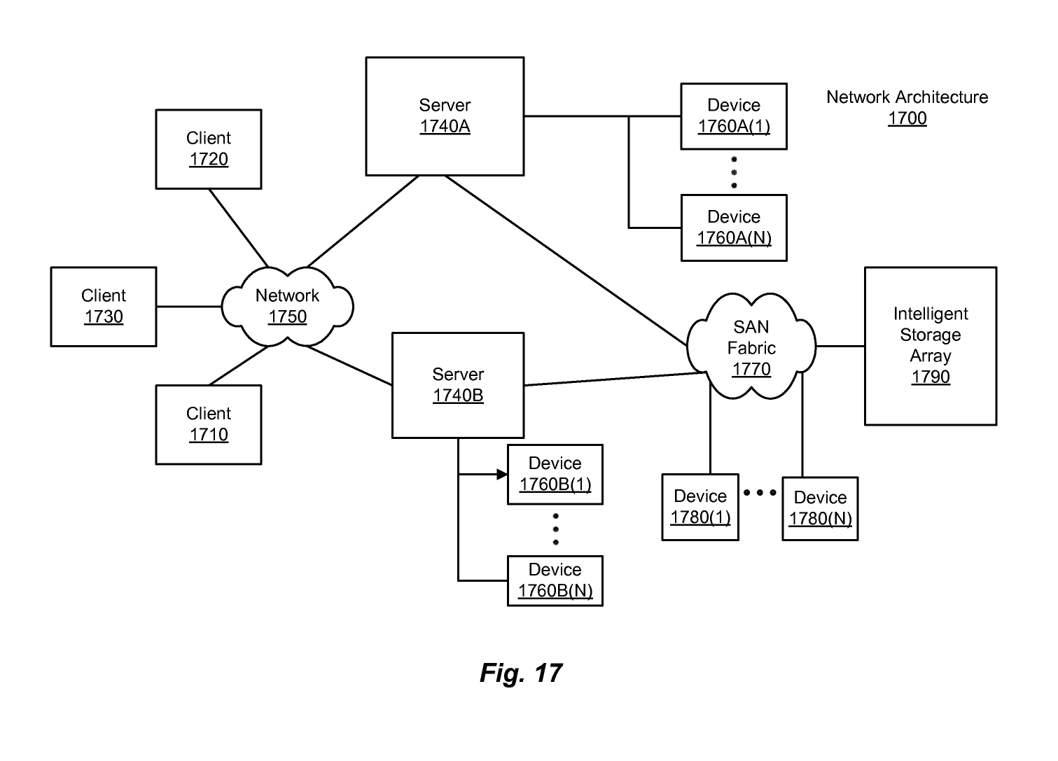

FIG. 3 is a simplified block diagram illustrating an example of a network architecture that includes a charging system according to embodiments of the methods and systems disclosed herein. Thus, FIG. 3 depicts a network architecture 300 as including a communications network (depicted in FIG. 3 as a communications network 310), which is configured to couple numerous of the elements of network architecture 300 to one another. In that regard (and among a number of such facilities provided thereby), communications network 310 supports communications between a number of subnetworks (depicted in FIG. 3 as subnetworks 320(1)-(N)). Subnetworks 320(1)-(N), in turn, can include a number of components, such as one or more clients (depicted in FIG. 3 as clients 325(1)-(N)) and/or servers (depicted in FIG. 3 as servers 330(1)-(N)). Clients 325(1)-(N) and/or servers 330(1)-(N) can, for example, be implemented using computer systems such as those described generically in connection with FIGS. 16 and 17. Communications network 310 thus communicatively couples subnetworks 320(1)-(N) to one another, thereby allowing clients 325(1)-(N) and servers 330(1)-(N) to communicate with one another (and can, in certain embodiments, provide for the servers of subnetworks 320(3) and 320(N), for example, to operate as cloud-based server systems). As is depicted in FIG. 3, clients 325(1)-(N) can be communicatively coupled to one another and to servers 330(1)-(N) as part of one of subnetworks 320(1)-(N), or directly via communications network 310. Similarly, servers 330(1)-(N) can be coupled via communications network 310 via a direct connection to communications network 310, or as part of one of subnetworks 320(1)-(N).

Network architecture 300 also provides for communication via communications network 310 using one or more other devices. Such devices can include, for example, a general packet radio service (GPRS) device (e.g., depicted in FIG. 1 as mobile devices 140(1)-(N)) (e.g., a “smart phone,” a “tablet” computer, or other such mobile device), a secure web client (e.g., a laptop computer running a secure hypertext transfer protocol (hypertext transfer protocol secure, or HTTPS), and depicted in FIG. 3 as an HTTPS client 350), and a basic cellular phone (e.g., using standard texting or other communication protocols, and depicted in FIG. 3 as a simple messaging service (SMS) client 360). Support for GPRS clients, SMS clients, HTTP clients, and the like thereby provide users with communication functionality according to an embodiment in a mobile environment. SMS client 360 can communicate via communications network 310 via several channels. SMS client 360 can communicate directly, for example, with a gateway 365, which, in turn, communicates with communications network 310 via a messaging gateway 367 and, optionally, elements within subnetwork 320(3), for example. Alternatively, SMS client 360 can, via gateway 365, communicate with subnetwork 320(3) (and so, communications network 310) via public messaging services 370 to which gateway 365 and subnetwork 320(3) are connected. As is also depicted in FIG. 3, a client 325(4) is also able to communicate via communications network 310 by way of public communication services 370 and subnetwork 320(3).

In order to support the aforementioned communications, as well as other communications within network architecture 300 according to various embodiments, subnetwork 320(3) includes a charging system 380, as well as (optionally) providing for a number of clients and/or other servers (not shown), in the manner of subnetworks 320(1)-(N). Charging system 380 supports communications within network architecture 300 by way of receiving usage information from and providing control information to the elements of network architecture 300, maintaining usage information, and performing other such functions. Such usage information can include, for example, accounting information, service usage, and other relevant information, as may relate to voice telephone calls, data transfers, messaging, and other such communications, as may occur between various of the elements of network architecture 300.

Charging system 380 includes a number of elements in support of these functions. Such elements include a charging engine 382, which is central to the functionality provided by charging system 380. Charging engine 382 provides information to and receives information from other elements of charging system 380, which can include, for example, a policy system 384, a mediation system 386, a pricing design system 388, and business support systems (BSS) 390. In so doing, charging engine 382 provides support for functions provided by policy system 384, mediation system 386, pricing design system 388, and BSS 390. The functionality provided by charging engine 382, policy system 384, mediation system 386, pricing design system 388, and BSS 390 are described in further detail subsequently herein.

Briefly, policy system 384 includes functionality that comprehends the design of policies to control operational aspects of charging system 380 by defining and enforcing (via, e.g., charging engine 382 and other elements of charging system 380) policies and rules resulting therefrom on the users of services provided via communications network 310 and other elements of network architecture 300. Similarly, pricing design system 388 can be used to design and implement pricing structures for the services provided within network architecture 300 by a service provider, allowing such a service provider to achieve fair pricing for their services, while helping to maintaining the profitability of those services. Business support systems 390 interact with charging engine 382 in order to allow the service provider to generate invoices, control access to the network, access other elements of charging system 380, and the like, as well as open, maintain, and close subscriber accounts as needed.

Mediation system 386 interacts with charging engine 382 in order to provide functionality related to controlling certain aspects of the provision of services throughout network architecture 300. Thus, in one embodiment mediation system 386 receives charging events from elements of network architecture 300, extracts event attributes, and generates a usage request. Mediation system 386 then submits the usage request to charging engine 382, which makes the requisite determinations and sends a usage response, indicating the outcome(s) of those determinations (e.g., granting or denying the usage request), to mediation system 386. Mediation system 386, in turn, interacts with various elements of network architecture 300 to effect the outcome(s) indicated by charging engine 382.

As will be appreciated in light of the present disclosure, a service provider such as that described herein (e.g., a telecommunication service provider, a shipping service provider, a utility service provider, and the like) provides subscribers with access to one or more service products. A service provider can implement a charging system that is configured to define and enforce conditions indicating how subscribers should be charged for service usage.

It will be appreciated that, in light of the present disclosure, the variable identifier “N” is used in several instances in various of the figures herein to more simply designate the final element of a series of related or similar elements. The repeated use of such variable identifiers is not meant to imply a correlation between the sizes of such series of elements. The use of variable identifiers of this sort in no way is intended to (and does not) require that each series of elements have the same number of elements as another series delimited by the same variable identifier. Rather, in each instance of use, variables thus identified may represent the same or a different value than other instances of the same variable identifier.

As will be appreciated in light of the present disclosure, processes according to concepts embodied by systems such as those described herein include one or more operations, which may be performed in any appropriate order. It is appreciated that operations discussed herein may consist of directly entered commands by a computer system user or by operations executed by application specific hardware modules, but the preferred embodiment includes operations executed by software modules. The functionality of operations referred to herein may correspond to the functionality of modules or portions of modules.

The operations referred to herein may be modules or portions of modules (e.g., software, firmware or hardware modules). For example, although the described embodiment includes software modules and/or includes manually entered user commands, the various example modules may be application specific hardware modules. The software modules discussed herein may include script, batch or other executable files, or combinations and/or portions of such files. The software modules may include a computer program or subroutines thereof encoded on computer-readable storage media.

Additionally, those skilled in the art will recognize that the boundaries between modules are merely illustrative and alternative embodiments may merge modules or impose an alternative decomposition of functionality of modules. For example, the modules discussed herein may be decomposed into submodules to be executed as multiple computer processes, and, optionally, on multiple computers. Moreover, alternative embodiments may combine multiple instances of a particular module or submodule. Furthermore, those skilled in the art will recognize that the operations described in example embodiment are for illustration only. Operations may be combined or the functionality of the operations may be distributed in additional operations in accordance with the invention.

Alternatively, such actions may be embodied in the structure of circuitry that implements such functionality, such as the micro-code of a complex instruction set computer (CISC), firmware programmed into programmable or erasable/programmable devices, the configuration of a field-programmable gate array (FPGA), the design of a gate array or full-custom application-specific integrated circuit (ASIC), or the like.

FIG. 4 is a simplified block diagram illustrating an example of network architecture, according to embodiments of the methods and systems disclosed herein. A network architecture 400 such as that depicted in FIG. 4 can include a number of systems and subsystems, some of which are comparable to those depicted in network architecture 300. For example, network architecture 400 includes a network 410, which communicatively couples a number of switching subsystems (depicted in FIG. 4 as switching subsystems 415(1)-(N)) to one another. Switching subsystems 415(1)-(N) couple a number of base stations (depicted in FIG. 4 as base stations 420(1,1)-(N,N)) to one another via network 410. In turn, base stations 420(1,1)-(N,N) provide a number of mobile devices (depicted in FIG. 4 as mobile devices 430(1,1)-(M, N)) with access to the communications facilities of network architecture 400. Such communications facilities can, for example, be provided in the manner of various ones of mobile devices 340(1)-(N), SMS client 360, clients 325(1)-(N), and other such elements of FIG. 3.

In the example depicted in FIG. 4, base stations 420(1,1)-(N,N) provide access between ones of mobile devices 430(1,1)-(M,N) using, for example, radio frequency communications. That being the case, base station 420(1,N) is depicted as including a base station control unit 440 and a transceiver 445. As can be seen in FIG. 4, transceiver 445 supports wireless communications with mobile devices 430(1,1)-(1,N), and provides these mobile devices with access to other such mobile devices on the network (e.g., via switching subsystem 415(1) and network 410). Base station control units such as base station control unit 440 handle connections (e.g., voice, data, messaging, and other such communications) between various ones of mobile devices 430(1,1)-(1,N), as well as to other elements of network architecture 400. For example, in a wireless (e.g., cellular) telephone system, the signals from one or more mobile telephones in a given area (typically referred to as a cell) are received at a base station such as base station 420(1,N), which then connects the call to other elements of network architecture 400. In such a case, elements of network 410 can include carrier, microwave radio, and/or switching facilities that connect calls from various ones of mobile devices 430(1,1)-(M,N) to various others of mobile devices 430(1,1)-(M,N).

Next, such a connection transits a switching center such as switching center 450 of switching subsystem 415(1). Switching center 450 performs functions such as switching incoming and outgoing voice and data connections, as well as interacting with a session controller 455 of switching subsystem 415(1), in order to support communications (e.g., voice calls) and tracking of such activity for purposes of billing and the like. To this end, session controller 455, as its name implies, controls communications sessions transiting switching centers such as switching center 450, and supports tracking of communications sessions for billing purposes (e.g., charging), communications session monitoring, voice and data traffic management, failure detection and recovery, and other such functions.

Switching subsystem 415(1), via session controller 455, communicates with a mediation system 460. Mediation system 460, depicted in FIG. 4 as an online mediation system, provides functionality related to the conversion of data of certain data types to other data types, typically for billing purposes, and can be implemented using one or more servers (a server, in turn, being implemented using one or more computing devices). A mediation system such as mediation system 460, among other functions, processes usage detail records (more specifically, call detail records (CDRs)) and handle information regarding voice and data calls such as call duration, peak time information, and the like.

Mediation system 460 is communicatively coupled to both one or more session controllers such as session controller 455, and a charging engine 470 (described subsequently). When a subscriber wishes to utilize a service, the subscriber's device (e.g., one of mobile devices 430(1,1)-(1,N)) attempts to make a connection, resulting in a request for the service (a service request) being sent to mediation system 460. Mediation system 460 processes call detail records and other such information received from session controller 455. A message processing service module within mediation system 460 generates a corresponding usage request and routes the usage request to the appropriate charging component of charging engine 470. Such a charging request includes a payload that contains information (e.g., from the relevant CDR(s)) in the form of attributes about the subscriber's service usage, such as the type of service being utilized and service usage measurements (e.g., volume-, time-, or event-based service usage measurements), and can be implemented using one or more servers, as well. In response, charging engine 470 utilizes the payload to perform the appropriate operations (e.g., charging the subscriber, performing authorization operations, and/or the like). Charging engine 470, which can perform charging functions for both offline and online charging, receives and operates on the information received from mediation system 460. Charging engine 470 then responds to the service request received from mediation system 460 with a response (a usage response) that indicates, for example, whether the service request is granted or denied.

In certain embodiments, charging engine 470 also provides information regarding communications sessions to a business support system (BSS) 480. BSS 480, in turn, includes a billing system (BS490 and a customer relationship management (CRM)/order management/order fulfillment system 495. Thus, in addition to maintaining information about and performing calculations regarding subscriber's use of services within network architecture 400, charging engine 470 provides communication providers with the ability to not only track usage of their network, but also control such usage. Thus, charging engine 470 provides business support system 480 with information regarding, for example, call detail records, for purposes of billing, accounting, and the like. As will be apparent in light of the present disclosure, BS 490 uses this information to generate information to subscribers, provide subscribers with information as to their accounts, and other such client-facing functions. Access to BS 490 can be had via CRM/ON/OF system 495, which provides a variety of functions relevant to the provision of services to subscribers, as well as subscriber access to accounts (e.g., via the web, or the like).

For service providers that provide subscribers with communications services using network architectures such as network architecture 400, latency in processing communications transactions is unacceptable because service quality is dependent upon the speed with which a service transaction (or an exchange of a usage request message and a usage response message) is completed, such as a service that cannot be provided to a subscriber until the subscriber or particular service usage (e.g., an event) is authorized by a charging engine. For example, a subscriber may not be able to make a cellular telephone call under a pre-paid service plan until the charging engine verifies that the subscriber has enough credit to initiate the call. In such a charging system, a service provider may define a performance goal of a maximum service transaction latency time of 50 milliseconds in the charging system, where latency of a service transaction is measured from the time a service request is sent to the charging engine from the mediation system until the time a corresponding service response is received at the mediation system from the charging engine.

And as the volume of communications sessions increases, the demands placed on such systems only increases, causing delays to lengthen and throughput levels to fall. Further, as the number of subscribers increases, the number of service transactions that need to be processed by the charging engine also increases, which in turn requires additional (and expensive) computing resources to monitor the latency of those service transactions. As a result, processing latencies increase exponentially, as the number of subscribers (and so service transactions) grew. For example, with 10 subscribers executing 10 service transactions each, 100 total service transactions would need to be processed. With 10 times that number of subscribers (100 subscribers) and service transactions (100 per subscriber), the total number of service transactions balloons to 10,000. As will be appreciated, then, subscriber experience must remain a focus when designing such systems.

Further still, not only is subscriber experience impacted by the speed with which such transactions are processed, but such communications are typically held to requirements set out in any number of applicable standards. The problems caused by the aforementioned exponential growth are only compounded when the need to service such transactions quickly to meet the requirements of standards is taken into account. For example, the relevant time constraints for certain communications sessions are often spelled out in widely-promulgated international standards, such as the 50 ms, 130 ms, and 1 s constraints mandated to avoid Carrier Group Alarms (CGAs) in the case of voice telephone calls adhering to various relevant standards (e.g., including, but not limited to, 3GPP™ IMS (and more particularly, 3GPP™ (Phases 1 and 2, and Releases 96-99 and 4-11)), Bell Communications Research (Bellcore; now Telcordia) General Requirements and Industry Standards (GR) GR-499, Bellcore GR-253 (including GR-253: Synchronous Optical Network (SONET) Transport Systems, Common Generic Criteria, Issue 5 [Bellcore, October 2009]), and ANSI (American National Standards Institute) T1.102, and the timing requirements therein, all of which are included herein by reference, in their entirety and for all purposes). If such increases in load are not addressed by the techniques employed, the processing overhead incurred while processing an ever-greater number of service transactions will slow the charging engine's processing of those service transactions, lengthening latency times and reducing throughput. Thus, in the case of time-critical services (e.g., voice telephone communications), the number of subscribers and service requests, along with the requirements of the relevant standards, quickly results in situations that become unworkable. These and other limitations and problems are addressed by systems according to the present disclosure.

To this end, the computing devices used to implement the servers noted elsewhere herein are therefore typically robust and computationally powerful. By employing high-performance computing platforms, such servers maximize throughput, and enable the provision of services quickly and efficiently. To this end, these server systems can be implemented using designs that are built for high-performance, in-memory operations. For example, such a server system can be designed to store multiple terabytes of data directly in memory, thereby providing for fast processing of data and communications based thereon, resulting in responsive performance that meets the timing requirements of the applicable technical standards. In one embodiment, such a server system supports high-speed main memory of 1 Terabyte (or more, depending on the element's needs) and 1.4 TB of high-speed second-tier memory (e.g., FLASH memory or the like) that can support hundreds of thousands of input/output operations per second, as well as bandwidth at the multi-gigabytes level. These memory layers are further backed by of hard disk storage (3.6 TBs or more), which is expandable (e.g., using Fibre Channel and other such high-speed technologies). Computationally, such a server system can include a processing package of 30 compute cores with hyper-threading. A generic example of such components is provided in connection with the discussion of FIGS. 16 and 17, below.

It will be appreciated that computing systems such as that described above, and the use of a datagrid (e.g., a grid-based high-availability cluster of servers) facilitates methods and systems such as those described herein. By maintaining data such as sharing group objects (discussed subsequently) in memory, fast, efficient processing of data needed to provide notification messages such as those described herein can be readily achieved.

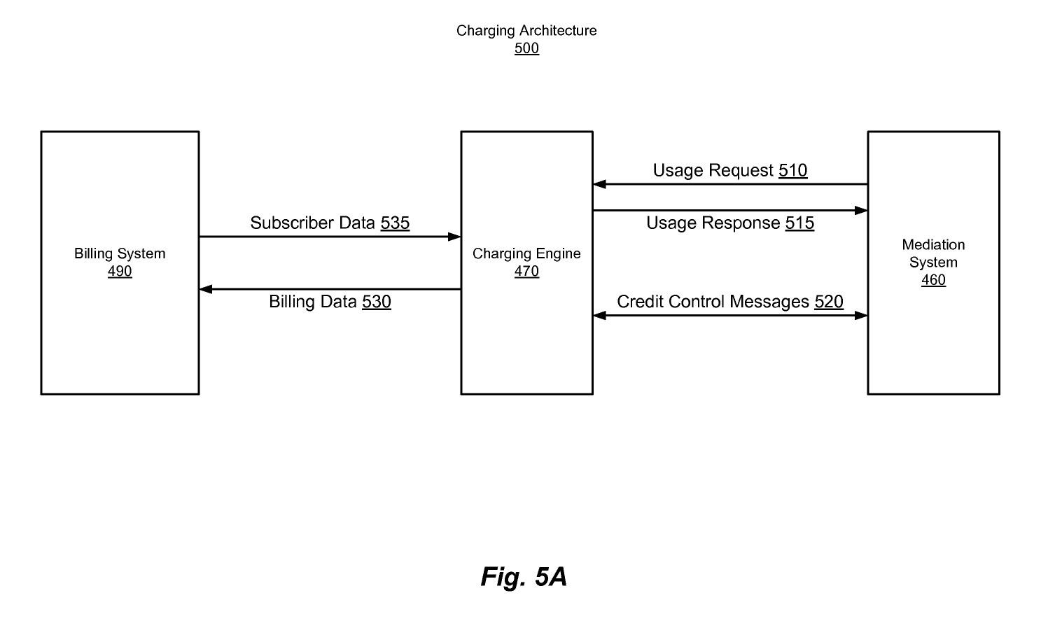

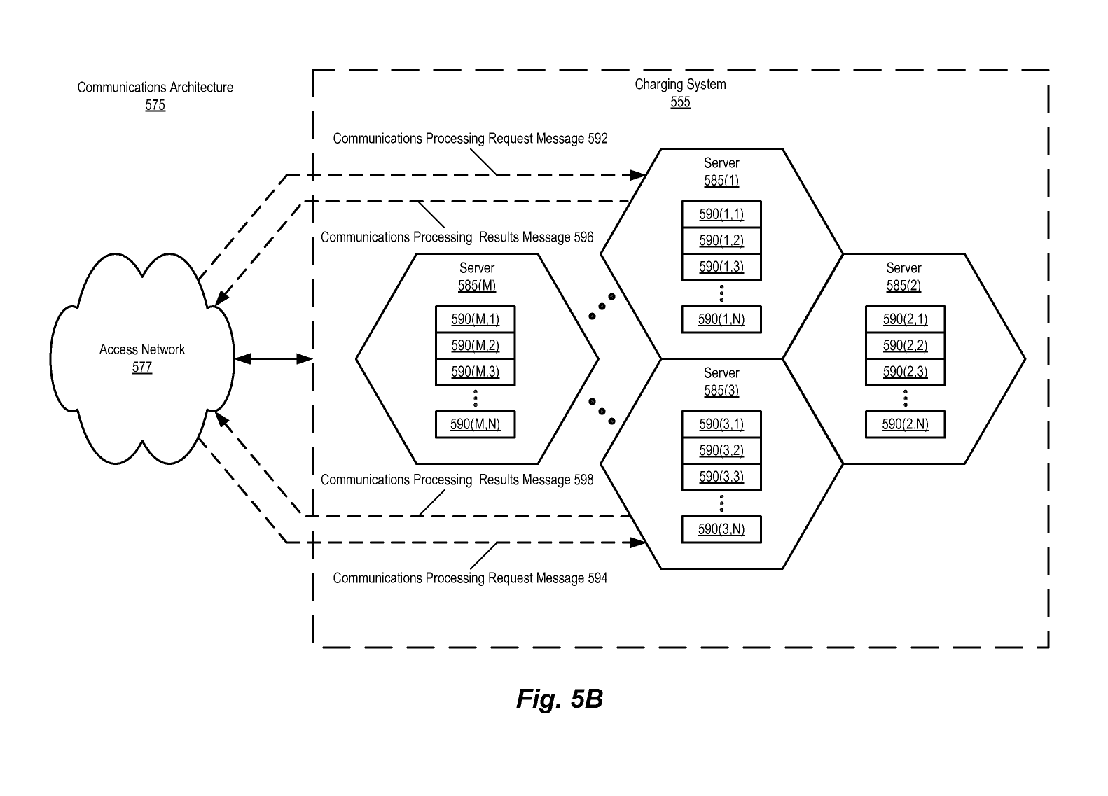

FIG. 5 is a simplified block diagram illustrating an example of a charging architecture, according to embodiments of the methods and systems disclosed herein. To this end, FIG. 5 depicts a charging architecture 500 in which mediation system 460, charging engine 470, and BS 490 of FIG. 4 appear. In a manner comparable to that discussed briefly with regard to FIG. 4, charging engine 470 acts as a central element of charging architecture 500, as well as network architecture 400. Various of the communications between these elements are now described in connection with charging architecture 500.

In this regard, mediation system 460, having received a request from, for example, session controller 455, sends a usage request to charging engine 470 (depicted in FIG. 5 as a usage request 510). As noted elsewhere, mediation system 460 can be implemented using one or more servers, such as those described above, and can be communicatively coupled to charging engine 470 and the relevant elements of the given network architecture (e.g., session controller 455) by way of an appropriate communications protocol (e.g., one or more IP (Internet Protocol) networks that utilize a communications protocol such as Ethernet, IEEE 802.11x, or some other communications protocol). The charging request received can include, for example, a payload that contains information in the form of attributes about the subscriber's service usage, such as the type of service being utilized and service usage measurements (e.g., volume-, time-, or event-based service usage measurements). Charging engine 470 and BS 490 are configured to utilize the payload to charge the subscriber or perform other authorization operations.

Charging engine 470 receives usage request 510 and makes certain determinations in relation thereto, and then provides mediation system 460 with a usage response 515. For example, mediation system 460 may send a usage request 510 to charging engine 470, indicating that a subscriber has initiated a voice telephone call and requesting that charging engine 470 grant a balance reservation in support of the request made on behalf of the subscriber's desired communication session.

As noted, charging engine 470 is configured to perform operations that determine (or allowed to be determined) charges that arise from a subscriber's service usage. Charging engine 470 can be implemented on one or more processing nodes, where the one or more processing nodes are implemented on one or more servers (such as on a grid-based high-availability cluster of servers, such as described earlier), and implemented on one or more computing devices. Charging engine 470 includes one or more charging components, each of which is responsible for performing a portion of the determinations needed to appropriately charge the subscriber for service usage. The charging components of charging engine 470 can be implemented on the one or more processing nodes of charging engine 470.

In turn, charging engine 470 responds with usage response 515 (e.g., granting the subscriber's communication session a balance reservation), thereby allowing the voice call to proceed. In addition, mediation system 460 and charging engine 470 may exchange credit control messages 520. Such credit control messages can include indications as to the need to terminate a session due to insufficient credit, information regarding the support of multiple services, origin- and destination-related information, and other such information. Charging engine 470 also communicates with BS 490, by, for example, providing billing data (depicted in FIG. 5 as billing data 530), while BS 490 can provide information regarding subscribers (depicted in FIG. 5 as subscriber data 535) to charging engine 470.

FIG. 5B is a simplified block diagram illustrating components of an example communications architecture, in which the present disclosure can be implemented, according to one embodiment. The communications architecture illustrated in FIG. 5B (and depicted in FIG. 5B as a communications architecture 575) employs a cluster of servers, each of which is capable of performing one or more (or all) of the requisite operations needed to process communications processing request messages received and generate communications processing results therefrom. Thus, in a fashion comparable to the architectures discussed earlier, communications architecture 575 includes an access network 577 and a charging system 580. In turn, charging system 580 includes a cluster of servers, which are communicatively coupled to one another to allow communication therebetween and facilitate global management thereof (depicted in FIG. 5B as servers 585(1)-(M)). As noted, each of servers 585(1)-(M) is capable of performing some or all of the operations requisite to one or more given tasks for which a given one of servers 585(1)-(M) might be assigned. In the example presented in FIG. 5B, each of servers 585(1)-(M) is assigned some number of operations to perform to accomplish their assigned tasks. Thus, for example, server 585(1) performs a number of operations (depicted in FIG. 5B as operations 590(1,1)-(1,N). Servers 585(2)-(M), similarly, perform operations associated with the tasks for which servers 585(2)-(M) are responsible (depicted in FIG. 5B as operations 590(2,1)-(M,N)).

In operation, communications architecture 575, and more specifically charging system 580, receive communications processing request messages, and, after performing the processing requested by the communications processing request messages, generate communications processing results in response thereto. Such exchanges are thus depicted in FIG. 5B as charging system 580 receiving communications processing request messages 592 and 594 from access network 577, at servers 585(1) and 585(3). Communications processing request messages 592 and 594 can be, for example, usage requests received from a mediation system. In response to communications processing request messages 592 and 594, servers 585(1) and 585(3) generate communications processing results messages 596 and 598, which are then sent by charging system 580 to various entities within access network 577. Communications processing results messages 596 and 598 can be, for example, a usage response sent to a mediation system. In contrast to the approach taken in communications architecture 550 of FIG. 5B, communications architecture 575, and more specifically charging system 580, are able to process communications processing request messages such as communications processing request messages 592 and 594 concurrently. Thus, communications processing request message 592 might be routed to server 585(1), at which juncture operations 590(1,1)-(N,1) are performed, in order to generate communications processing results messages 596. Similarly, communications processing messages 594 can be routed to, for example, server 585(3), at which juncture the requisite operations (operations 590(1, 3)-(N, 3)) are performed, in order to generate charging results 598, which are then sent from charging system 580 to the appropriate entities within access network 577.

The distributed nature of communications architectures such as communications architecture 575 pose numerous technical challenges to maintaining performance, particularly as the number of subscribers grows. Even when the workload represented by a large number of subscribers is balanced across a large number of nodes (e.g., computing entities such as servers 585(1)-(N)), which can be achieved using techniques such as hashing subscriber identifiers to spread subscribers evenly among computing entities, computational demands continue to rise. Approaches such as those described herein help to address such challenges, and in so doing, provide performance that is scalable, correct, and fault-tolerant, without incurring the overhead involved in other approaches that would ultimately impede transaction processing unacceptably.

As noted, communications architectures such as communications architecture 575 can be employed in satisfying communications processing requests. Further, as noted briefly above, some combination of such architectures can be employed, depending on the application and other details of the given situation. Further, other architectures (not shown) can also be employed to good effect. While the many benefits of systems according to the present disclosure will be evident in light of the present disclosure, it should be appreciated that the more complex the architecture, the greater the benefits of the low-overhead nature of such systems.

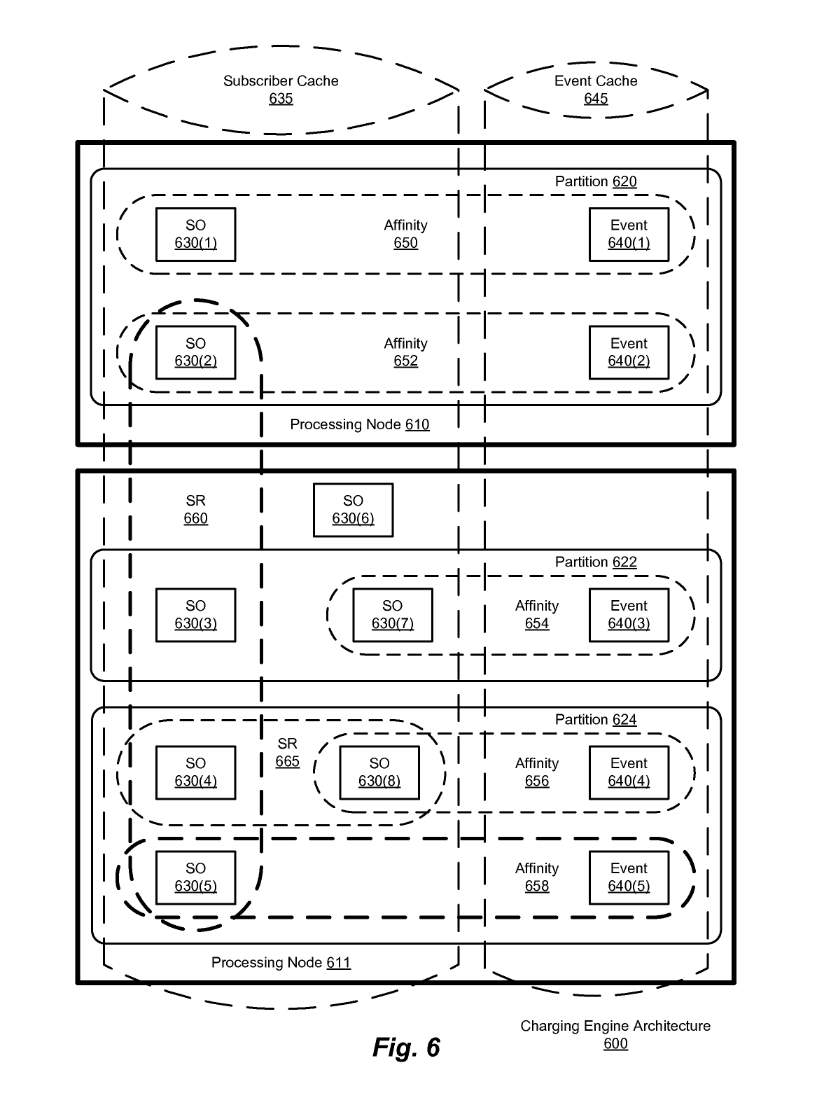

FIG. 6 is a simplified block diagram illustrating an example of a charging engine architecture 600 in which subscriber objects and events can be processed according to embodiments of the methods and systems disclosed herein. Charging engine architecture 600 includes a number of processing nodes (depicted, as examples, in FIG. 6 as processing nodes 610 and 611), which correspond, if loosely, to ones of servers 585(1)-(N) of FIG. 5B. As before, it will be appreciated that, in light of the present disclosure, processing nodes 610 and 611 can be implemented by any number of process implementations (e.g., Java™ applications, processing nodes, and/or other such computing and/or storage entities). Processing nodes 610 and 611, in turn, provide hardware and software support for some number of partitions (depicted in FIG. 6 as partitions 620, 622, and 624). Partitions 620, 622, and 624 can be created, for example, through the use of hash partitioning, where the constructs representing subscribers (e.g., subscriber objects) are, for practical purposes, evenly spread among the partitions created by assigning each such subscriber object based on a hash value (hash key) created from some unique information associated with the corresponding subscriber (e.g., subscriber identifier). It will be appreciated that partitions such as partitions 620, 622, and 624 can be created and maintained in separate processes (not shown for the sake of simplicity).

Across partitions 620, 622, and 624 (and so processing nodes 610 and 611) are distributed a number of subscriber objects (depicted, as examples, in FIG. 6 as subscriber objects 630(1)-(8)). In a manner comparable to that described earlier, subscriber objects 630(1)-(8) are treated as being logically related to one another (though not necessarily in a distributed relationship) through the use of a construct referred to herein as a subscriber cache (and depicted in FIG. 6, by way of example, as a subscriber cache 635). In comparable fashion, also maintained are some number of events (depicted, as examples, in FIG. 6 as events 640(1)-(5)), which are similarly maintained in an event cache (and depicted in FIG. 6, by way of example, as an event cache 645). As can be seen in FIG. 6, subscriber cache 635 and event cache 645 are distributed, and thus, subscriber objects and events, being distributed therein (across partitions/processing nodes), would otherwise need a distributed transaction or migration mechanism in order to effect the transactions contemplated by the methods and systems described herein.

When a transaction is to occur (referred to in this example as an event (e.g., represented by an event object, such as events 640(1)-(5))), the event determines its intended subscriber object using the subscriber's identifier, determining which partition (and so, processing node) to employ. Thus, by way of such identifying information, an event can be associated with its intended subscriber. Such associations are depicted in FIG. 6 as affinities 650, 652, 654, 656, and 658.

As will be appreciated in light of the present disclosure, transactions performed on multiple ones of subscriber objects 630(1)-(8) (e.g., as a result of such objects being in distributed relationships (referred to in this example as sharing relationships)) can encounter problems such as those described earlier (e.g., that involve modifying such objects, including the modification of the information maintained thereby). For example, subscriber objects 630(2), 630(3), 630(4), and 630(5) are in a sharing relationship (SR) 660, while subscriber objects 630(4) and 630(8) are in a sharing relationship (SR) 665. As will also be appreciated in light of the present disclosure, a given subscriber object need not be a member of a sharing relationship (e.g., as demonstrated by subscriber objects 630(1), 630(6), and 630(7) (nor, in fact, will all subscriber objects be subject to an event at any given time (e.g., subscriber object 630(6), which has no affinity to an event)).

As can be seen, a transaction performed against one of the subscriber objects in a sharing relationship will (or at least, could) affect the subscriber objects of other subscribers in that subscriber group. Thus, a transaction such as might be performed against subscriber object 630(8) would affect subscriber object 630(4), as subscriber objects 630(4) and 630(8) are in sharing relationship 655. Such a situation is depicted in FIG. 6 by affinity 656, which represents an transaction (event 640(4)) to be performed on subscriber object 630(8), and so involving subscriber object 630(4). In a similar fashion, a transaction might be performed against subscriber object 630(5), which would affect subscriber objects 630(2), 630(3), and 630(4), as subscriber objects 630(2), 630(3), 630(4), and 630(5) are in sharing relationship 650. Such a situation is depicted in FIG. 6 by affinity 658, which represents an transaction (event 640(5)) to be performed on subscriber object 630(5), and so involving subscriber objects 630(2), 630(3), and 630(4). The objects in sharing relationships 650 and 655 would thus encounter the challenges described earlier, were such a transaction to employ either migration or a distributed transaction. However, as noted, by performing operations such as those described herein, such a transaction can be effected without encountering such untoward effects, while maintaining a high level of performance.

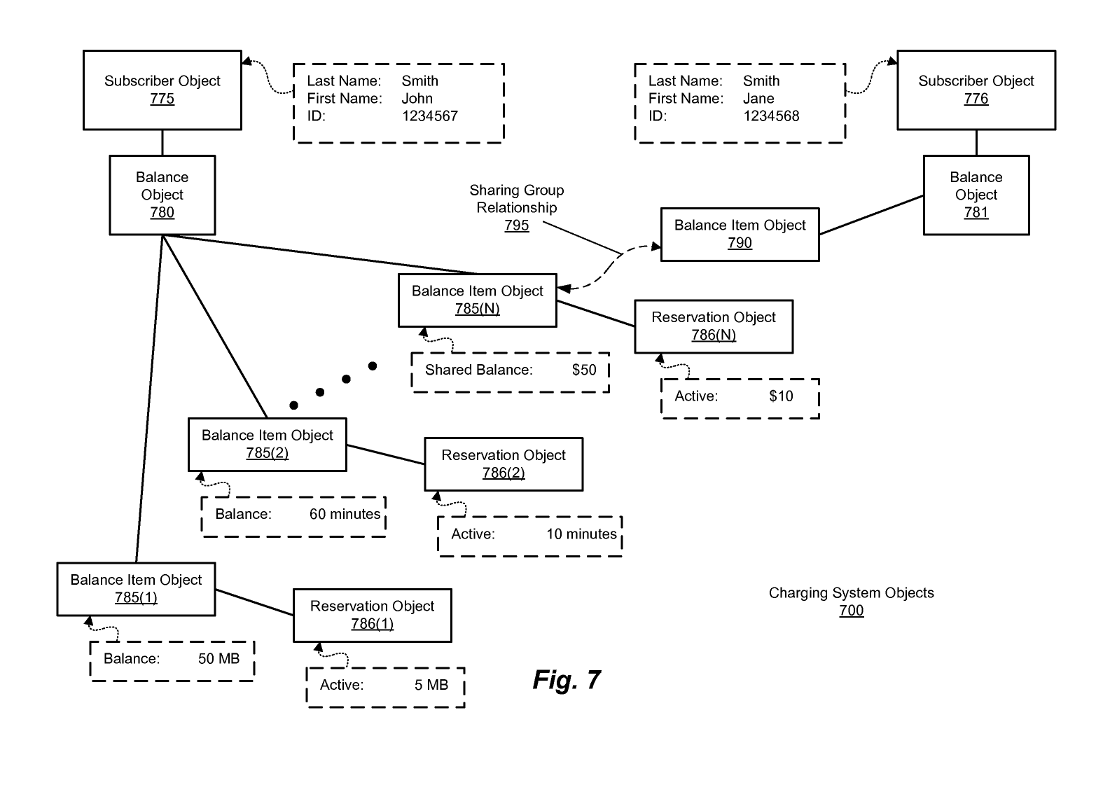

FIG. 7 is a simplified block diagram illustrating an example of charging system objects, according to embodiments of the methods and systems disclosed herein. FIG. 7 thus depicts a number of charging system objects (depicted in FIG. 7 as charging system objects 700), which provide examples of the structures in which balance information according to the methods and systems disclosed herein can be stored and processed. That being the case, charging system objects 700 include subscriber objects 775 and 776. Subscriber object 775 has one or more child objects (e.g., depicted in FIG. 7 as a balance object 780). Similarly, subscriber object 776 also has one or more child objects (e.g., depicted in FIG. 7 as a balance object 781).

Subscriber objects 775 and 776 maintain information regarding their respective subscribers, which can include, for example, a last name, a first name, and an identification number (examples of which are depicted in FIG. 7). Subscriber information maintained in subscriber objects 775 and 751 can, for example, include information such as the subscriber information obtained in the processes elsewhere herein, as relate to the creation and maintenance of subscriber accounts, including the sharing relationships described herein. Balance object 780 has child objects, for example, which include a number of balance item objects (depicted in FIG. 7 as balance item objects 785(1)-(N)). In turn, balance item objects 785(1)-(N) have as child objects one or more reservation objects (depicted in FIG. 7 as reservation objects 786(1)-(N). As can be seen in FIG. 7, balance item objects 785(1)-(N) maintain information regarding a subscriber's balances for a given type of service (e.g., balance item object 785(1) maintains information regarding a data balance (here, 50 MB); balance item object 785(2) maintains information regarding remaining minutes for voice telephone calls (here, 60 minutes); and balance item object 785(N) maintains information regarding a dollar value balance for another service (or for use in the subscriber's data or voice sessions (here, $50)). Similarly, reservation objects 786(1)-(N) maintain information regarding a given communications session using a corresponding service, and indicate the amount of balance presently reserved. Such information can be used in the processes described earlier, for example. In comparable fashion, balance object 781 also has child objects, for example, which include a number of balance item objects (an example of which is depicted in FIG. 7 as a balance item object 790).

As can also be seen in FIG. 7, balance item objects 785(N) and 790 are associated with one another by way of a sharing group relationship 795. It will be appreciated that sharing group relationship 795 is merely a logical representation of a sharing group balance, and that information regarding the sharing relationship between the balances of the subscribers represented by subscriber objects 775 and 776 can be maintained, for example, in a sharing group balance object or other such construct, as well as the existence of and subscriber information for one or more subscribers in the sharing group, in a sharing group object (as maintained, e.g., by a charging engine or other such system). Thus, while the shared balance in FIG. 7 is illustrated as being maintained in both balance item objects 785(N) and 790, such shared balance information can be maintained in a sharing group balance object (or other construct), in one or the other of balance item objects 785(N) and 790, or in another construct as may be deemed advantageous in the design of charging systems such as those described herein. It will be appreciated that, as depicted in FIG. 7, the subscriber represented by subscriber object 775 is the active subscriber (e.g., as observed in connection with charging timeline 500 of FIG. 5), which is reflected by reservation object 786(N) reflecting an active balance reservation of $10 (which is reserved against the shared balance that is shared between the subscribers represented by subscriber objects 775 and 776).

Further, the structure of charging system objects 700 lends itself to facilitating processes such as those described herein. An architecture employing objects such as charging system objects 700 offers, for example, a runtime model that provides fine-grained control over and tracking of information through the use of domain entities. The persistence model such domain entities offers also provides for coarse-grained control over characteristics that may apply to a number of such constructs. Benefits include the efficient storage of and access to such information, and compact representation of such information in the memory and storage systems of charging systems such as those described herein.

With regard to the elements of FIG. 7, the subscriber, as indicated in relation to subscriber object 775, is one John Smith with a subscriber identifier of 1234567 (which can be, for example, a telephone number, of the form (area_code) 123-4567). Subscriber John Smith's balance, as depicted in relation to balance item object 785(N), is currently $50, with an active balance reservation of $10 and a consumed balance reservation of $15 (as indicated in relation to reservation object 786(N)). Further, subscriber John Smith has a “free minute” balance of 70 minutes, with an active balance reservation of 10 minutes and a consumed balance reservation of 25 minutes (in relation to balance item object 785(2) and reservation object 786(2), respectively). In a similar fashion, subscriber John Smith has a data balance of 60 MB, with an active balance reservation of 5 MB and a consumed balance reservation of 15 MB (in relation to balance item object 785(1) and reservation object 786(1), respectively). Comparable information can thus be maintained for Jane Smith (represented by subscriber object 776). It will be noted that, for John Smith, only the balance represented by balance item object 785(N) is shared—balance item objects 785(1)-(N−1) are individual balances. To this end, John Smith is free to use the balances indicated in balance item objects 785(1)-(N−1) without regard to any sharing relationship. It will be further appreciated that a given subscriber's account can be configured with any number of individual (non-shared) and shared balances, in any combination and to any level of complexity. Such scenarios are intended to come within the scope of this disclosure, and as such, will enjoy the benefits of methods and systems such as those described herein.

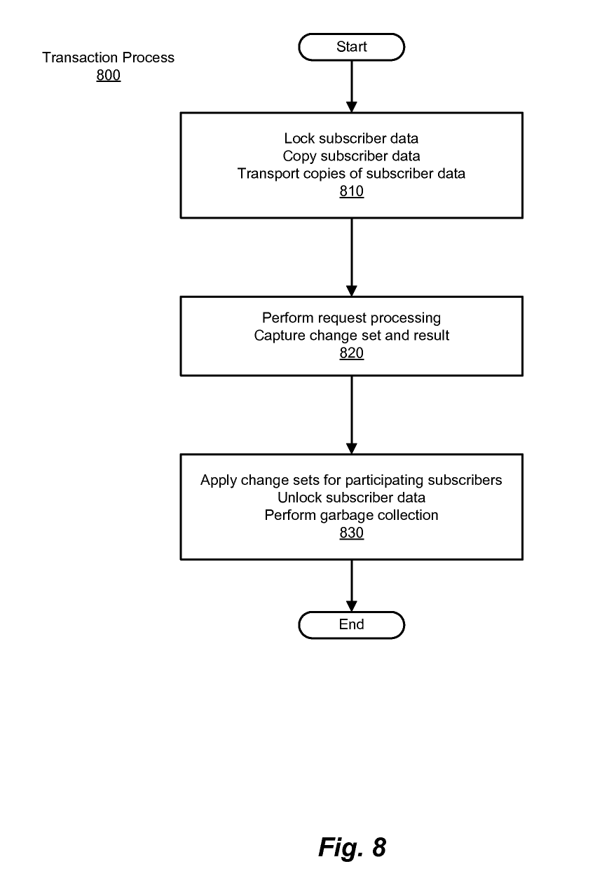

FIG. 8 is a simplified flow diagram illustrating an example of the operations performed in effecting a transaction process 800 on subscriber objects in a sharing relationship, according to embodiments of the methods and systems disclosed herein. Returning to the service subscriber scenario presented earlier, the three aforementioned operations are performed in processing a transaction involving a sharing relationship between subscribers of such services (e.g., a mobile service provider).

Using the earlier-discussed service subscriber scenario as an example, the three aforementioned operations can be performed in processing a transaction involving a sharing relationship between subscribers of such services (e.g., a mobile communications service provider) as follows:
OPERATION 1: PREPARATION (step 810)
   Reserve (lock) the requisite subscriber data (that of the primary subscriber and secondary subscribers in sharing group)
   Copy the requisite subscriber data
   Transport copy/copies of secondary subscriber data to primary partition
OPERATION 2: PROCESSING (step 820)
   Perform request processing involving a sharing relationship (the outcome of the processing operation is not immediately reflected in all of the subscribers participating in the sharing relationship)
   Capture change set for each participating subscriber together with the main processing result
OPERATION 3: POST-PROCESSING (step 830)
   Apply change sets for participating subscribers (primary and secondary subscriber objects)
   Release reservations
   Delete change set

In certain embodiments, each transaction is associated with a unique key. Successful change of a subscriber state through a processing operation can thus result in a record of the fact that this operation was completed successfully. This record is associated with the transaction key. Subsequent retries of the same processing operation check the record to ensure that the same subscriber state change does not happen twice. Such an embodiment can be implemented as four activity flows:
Regular Processing How (enrichment, charging, usage response, rated event)
Insert Rated Event Processing Flow (usage response, rated event)
Remove Object From Customer Processing Flow (delete-close subscriber object)
Delivery Usage Response Processing Flow (usage response)

### Example Operations in a Charging Environment Using a Three Entry Processor Approach

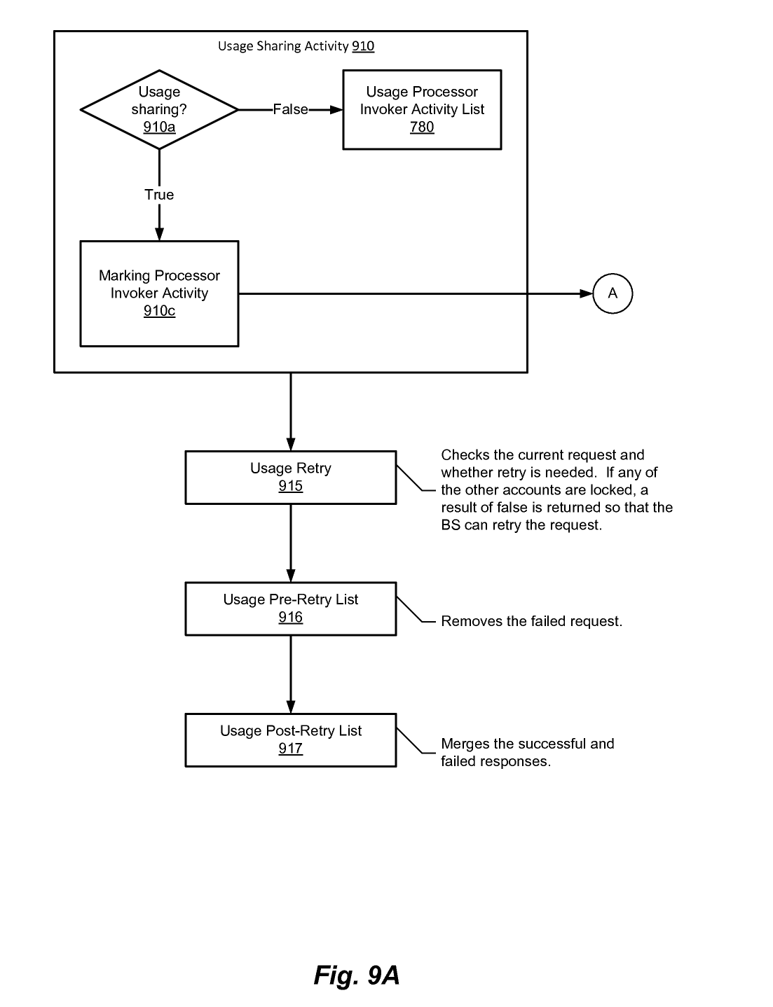

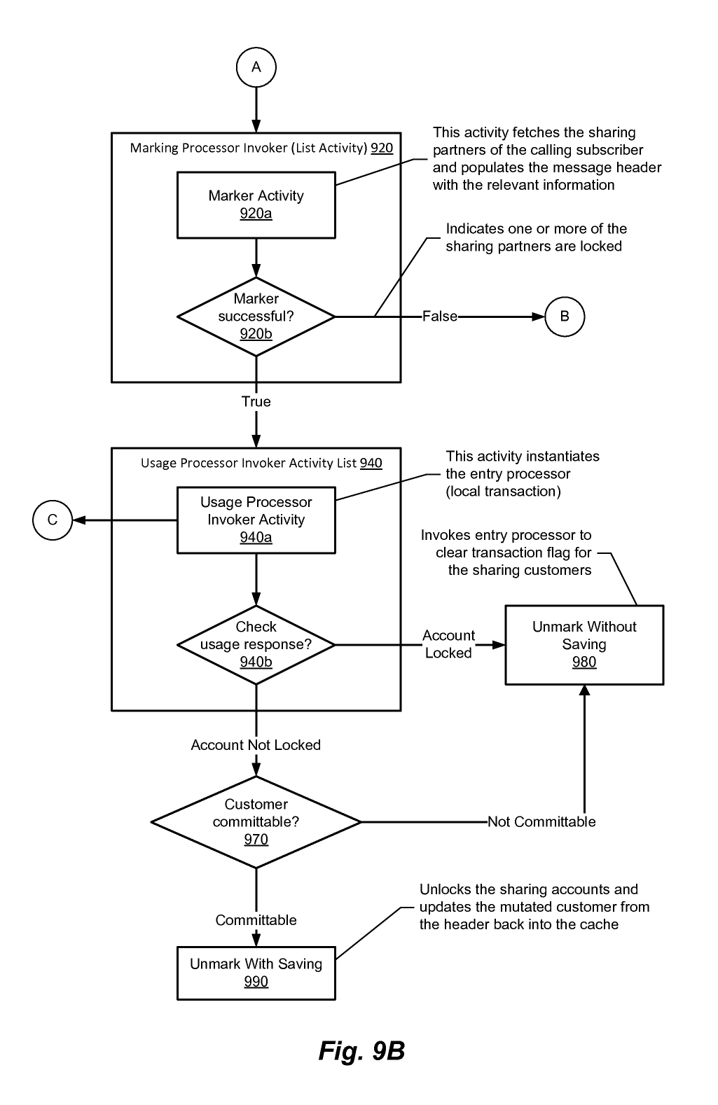

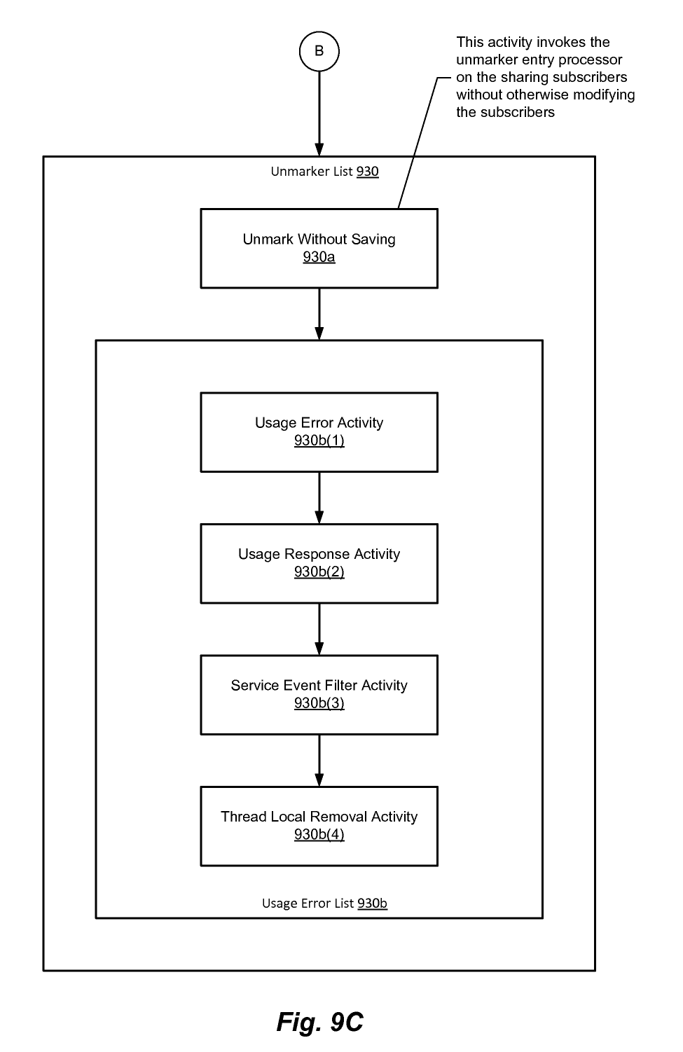

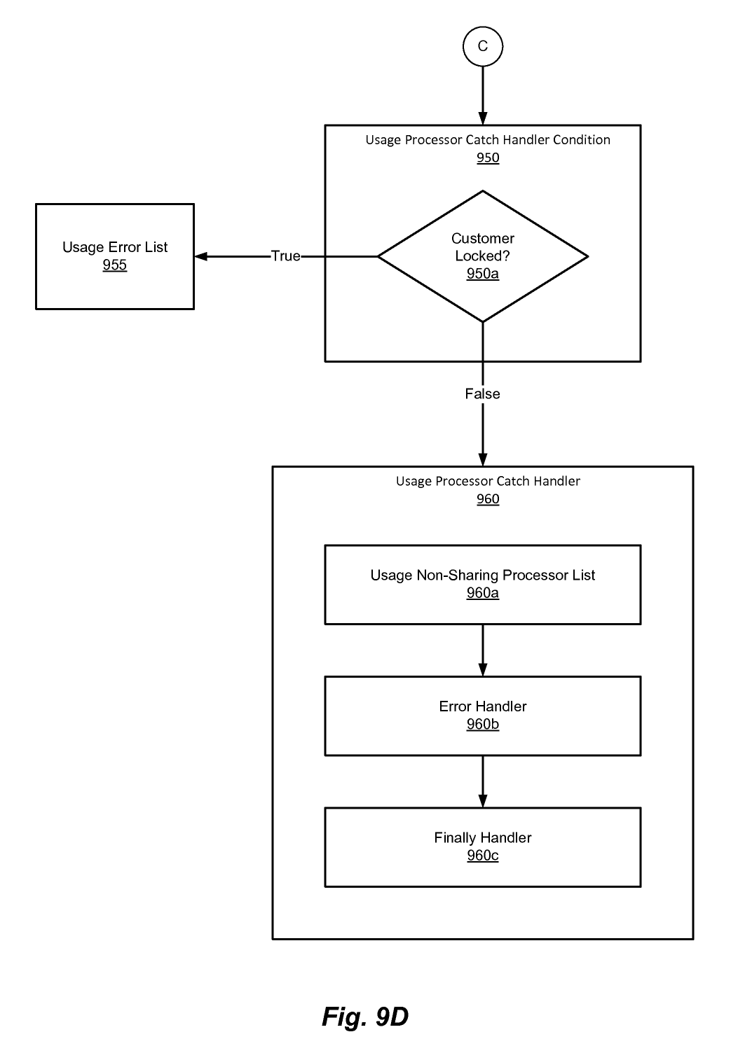

FIG. 9 is a simplified activity framework flow diagram illustrating an example of a three entry processor approach, according to embodiments of the methods and systems disclosed herein. This embodiment illustrates a sharing transaction process 900 that depicts operations involved in the three entry processor approach:
First EP marks the customers (subscribers) in the given sharing relationship(s)
   This is a local transaction
Second EP performs a normal usage flow
   This is a local transaction
Third EP unmarks and saves sharing customers
   This is a local transaction

Sharing transaction process 900 begins with a usage sharing activity 910. Usage sharing activity 910, in turn, determines whether usage sharing is to occur (910a). If not, the transaction is performed in the usual manner (910b). If the request is denied for some reason, a determination is made as to the form that a retry should take (915), the failed request is removed (916), and the response merged in with other such responses (917).

Otherwise, a mark sharing partner processor is invoked (910c). Initiation of an RPC for the mark sharing partner processor result in the process advancing to a mark process invoker (920), which effects a mark (customer) activity (920a). A determination is then made as to whether the mark activity (e.g., a mark sharing partner processor) was successfully invoked (920b). If the mark activity was not successfully invoked (indicating, e.g., that one or more of the sharing partners was found to be locked), processing advances to an unmarked list (930), where the customer(s) in question are unmarked without saving (930a) and a usage list updated (930b). Updating the usage list includes a usage error activity (930b(1)), a usage response activity (930b(2)), a service event activity (930b(3)), and a local removal activity (930b(4)).

If the marking of the customer is successful, processing advances to initiation of an RPC for a usage processor (940). This includes the performance of a usage processor invoker activity (940a). The performance of this activity includes a determination as to whether a condition indicating that the customer in question being locked (950). If the customer in question is locked (950a), information regarding the incident is recorded in a usage error list (955). If the customer in question is not locked (i.e., unlocked (950a), processing advances to an operation that records the customer's state as being unlocked (960), which includes processing a list of non-sharing customers (960a), processing performed by an error handler (960b), and processing performed by a finality handler (960c).

Once the foregoing processing has been performed, processing within the usage processor advances to a determination as to the outcome of the usage response for the customer in question (940b). If the customer (the customer's account) is not locked, processing advances to a determination as to whether information regarding the customer is “committable” (i.e., can be committed to the customer's balance information) (970). If the customer is not committable (or if the customer is locked), processing advances to the customer being unmarked without saving the information thereto (980). The processing then concludes. However, if the customer is committable, information (e.g., balance information) is saved to the customers' accounts and their accounts are unlocked (990).

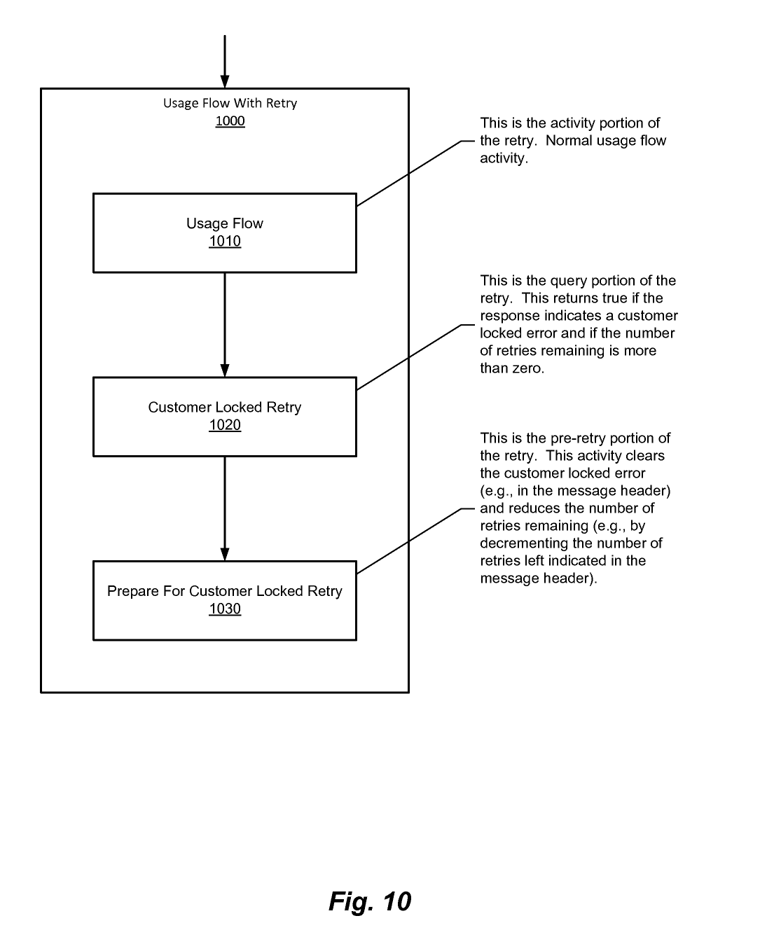

FIG. 10 is a simplified activity framework flow diagram illustrating an example of a retry activity sequence, according to embodiments of the methods and systems disclosed herein. The usage flow can be embedded, for example, in a Retry Activity such as that shown in FIG. 10. This is the server-side retry when the account is locked. Operations included in a usage flow with retry (1000) include a usage flow (1010), a retry on customer lock (1020), and an operation to prepare for a retry if the customer is locked (1030). The usage flow is the activity portion of the retry operation. The query portion of the retry operation is the query performed to retry, when the customer is locked (returning a “true” value if the customer was locked and there are more retries available). Preparing for a retry (if the customer is locked) includes clearing the error indicator relating to the customer being locked, and decrements the number of retries left before the operation is considered to have failed.

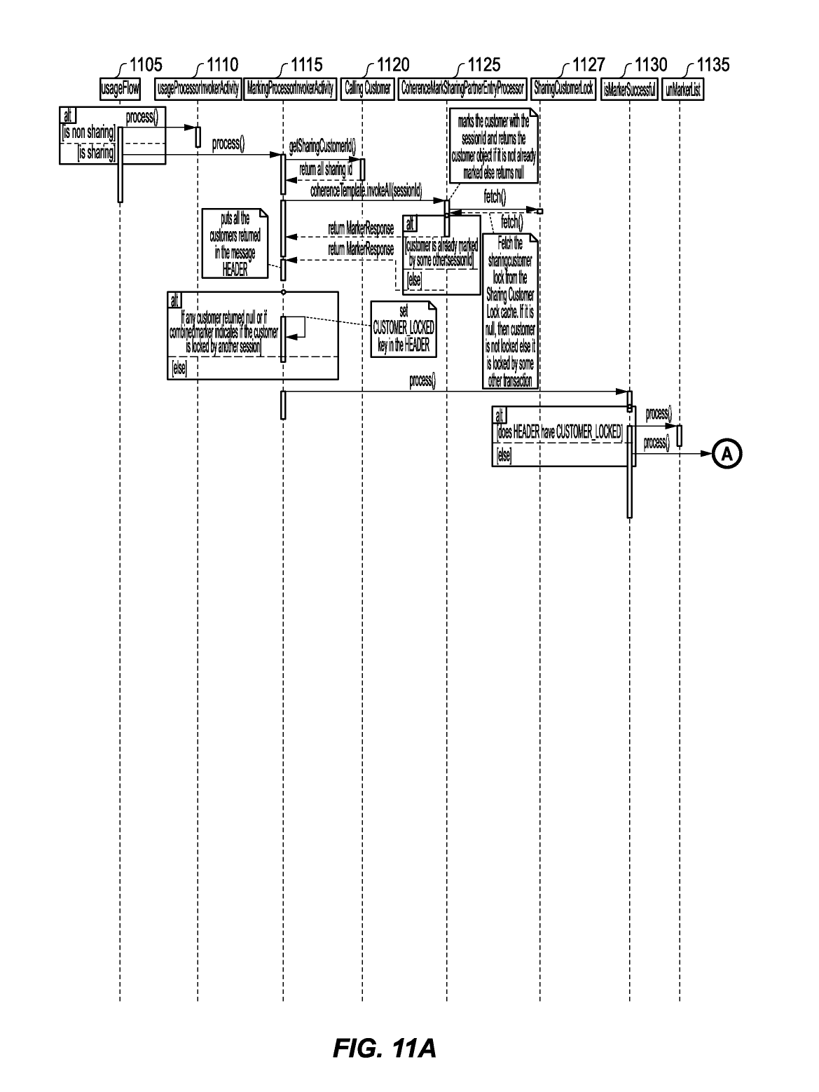

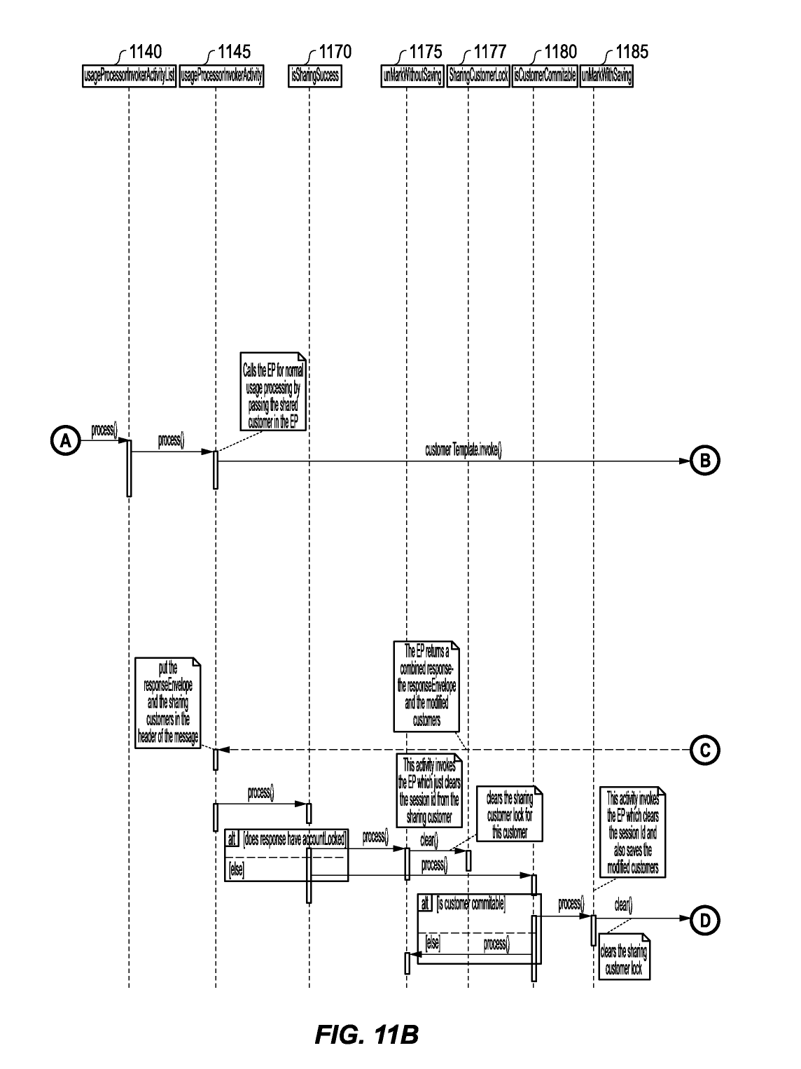

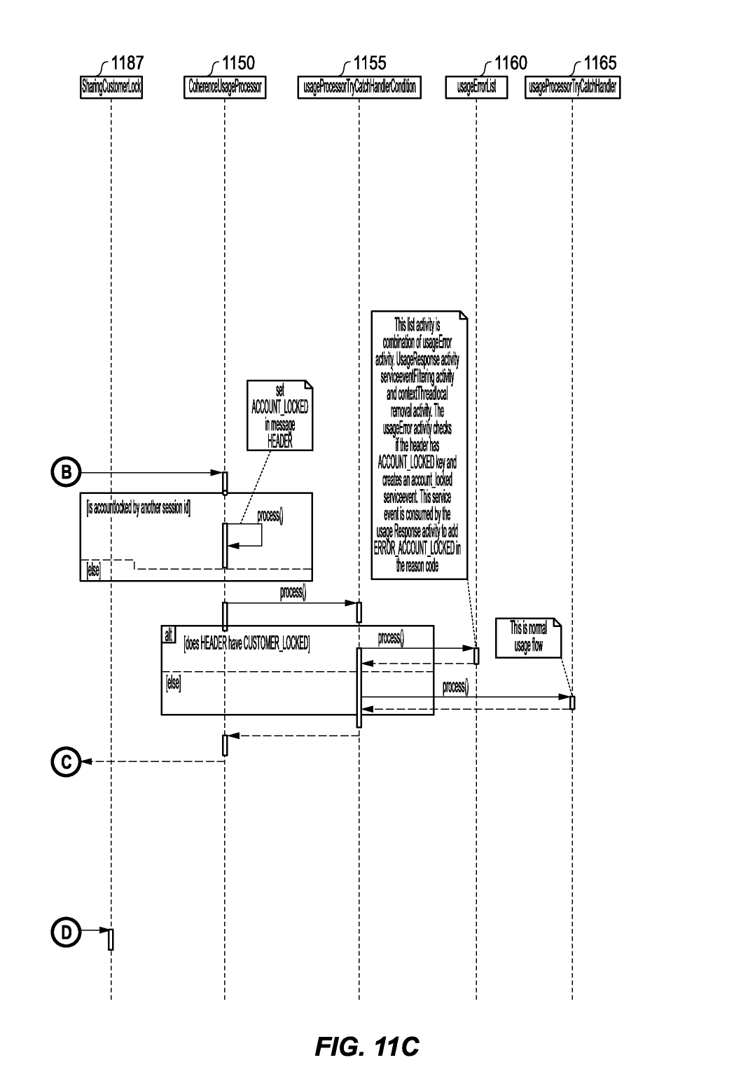

FIG. 11 is a simplified sequence diagram illustrating an example of a usage transaction sequence, according to embodiments of the methods and systems disclosed herein. The transaction sequence depicted in FIG. 11 illustrates the sequence of the usage flow for the server-side re-try when the account is locked. The simplified sequence diagram of FIG. 11 follows the simplified activity framework flow diagram of FIG. 8. It is expected that such conditions will be infrequent, owing to the speed with which this process effects the requisite processing.

The process illustrated by the sequence diagram of FIG. 11 begins with a determination in a usage flow 1105 as to whether the customer in question is in a sharing relationship by availing itself of a usage processor invoker activity 1110. If usage processor invoker activity 1110 indicates that the customer in question (the calling customer) is in a sharing relationship, usage flow 1105 proceeds to a marking processor invoker activity 1115, which interacts with a calling customer 1120 to obtain information regarding any sharing relationships that exist with respect to the transaction at hand (or, in this example, the sharing relationship that involves the sharing customers in question). Marking processor invoker activity 1115 also interacts with a mark sharing partner EP 1125 by invoking mark sharing partner EP 1125 with the session identifier. This marks the customer with the session identifier, and fetches a sharing customer lock 1127 from a sharing customer lock cache. In certain embodiments, if a null value is returned, the response indicates that the customer is not locked (otherwise, the customer is locked). In any event, if the marking was successful, mark sharing partner EP 1125 returns an indication to that effect, and the process proceeds. Otherwise, the process (marking processor invoker activity 1115) can wait for the unavailable sharing customers to become available, for example (e.g., a null value is returned for one or more sharing customers, or a combined marker indicates such).

The sequence can then proceed to a marker successful activity 1130. If the marking operations were not successful, marker successful activity 1130 interacts with an unmark list process 1135, which unmarks the marked customers, such that the transaction can be retried, for example. If the “customer locked” key and/or returned values indicate that the marking was successful, marker successful activity 1130 interacts with a usage processor invoker activity list 1140. Usage processor invoker activity list 1140 then interacts with a usage processor invoker activity 1145, which calls the entry processor for normal usage processing by passing the shared customers in the EP. In certain embodiments, usage processor invoker activity 1145 performs a customer template invoke operation, and in so doing, invokes a usage processor 1150. Usage processor 1150, in turn, performs operations (locking the account using the session identifier (and waiting until the account is no longer locked by another, if necessary)) and interacts with usage processor condition 1155, which interacts with a usage error list 1160, and usage processor handler 1165.

The EP that is usage processor 1150 then provides a combined response to usage processor invoker activity 1145. Usage processor invoker activity 1145 then interacts with a process of determining whether the sharing operation was successful (the customer was unlocked) (1170). If the response indicates that the account was locked (is sharing locked 1770, in the manner described earlier), if the customer was locked, a process that unmarks the customer without saving the information (1175 and 1177) is performed. If the customer was not locked (1170), a determination is made as to whether the customer is committable (1180). If the customer was not locked (1170) and the customer is committable (1180), a process of unmarking the customer that includes saving the requisite information is performed (1185 and 1187).

As noted, then, in the three EP approach, there can be three points of failure (caused, e.g., by hardware failures, software failures, and the like). Using the example above:
Between EP1 and EP2—the sharing customers would have been marked, so when the node goes down and the mediation system resubmits the request, EP1 returns a message with ‘SHARING_CUSTOMERS_MARKED’ in the message header (indicating a possible duplicate). In the normal usage flow, a response is sent that indicates non-duplicate, and EP2 saves the owned customer balances into the ‘SharedCustomerState’ cache. Unmarker activity reads this information and passes to EP3, which saves the information.
Between EP2 and EP3—the sharing customers would have been marked, so when the node goes down and the mediation system resubmits the request, EP1 returns a message with ‘SHARING_CUSTOMERS_MARKED’ in the message header (indicating a possible duplicate). In the normal flow, a response is sent that indicates a duplicate. Unmarker reads the ‘SharedCustomerState’ cache and passes that information to EP3, which saves the information. Unmarker later removes the SharedCustomerState entry.
Between EP3 and removal of SharedCustomerState entry—the sharing customers would be unMarked, so when the node goes down and the mediation system resubmits the request, EP1 marks these customers. In the normal flow, a response is sent that indicates a duplicate and so Unmarker activity unmarks the owner customers (without saving the balances) in EP3. Unmarker later removes the SharedCustomerState entry.

Possible enhancements to such processes are numerous, and are intended to come within the scope of this disclosure. For example, it will be appreciated that a separate cache can be used for the shared customer state. This cache has the sharing customer's product state and balance state (product state is used for item list and next item list (if usage crosses billing boundary and the next item list is not populated)). Another possibility is, as a part of EP2 (Usage Flow), balances for the owner customer can be put into the ‘SharedCustomerState’ cache using a local transaction, against the caller (using, e.g., customerId and sessionId key). Once in the unMarker activity, get these balances from the ‘SharedCustomerState’ cache and pass them to EP3, which saves them. When EP3 commits, the entry can be removed from the ‘SharedCustomerState’ cache as a part of unMarker activity.

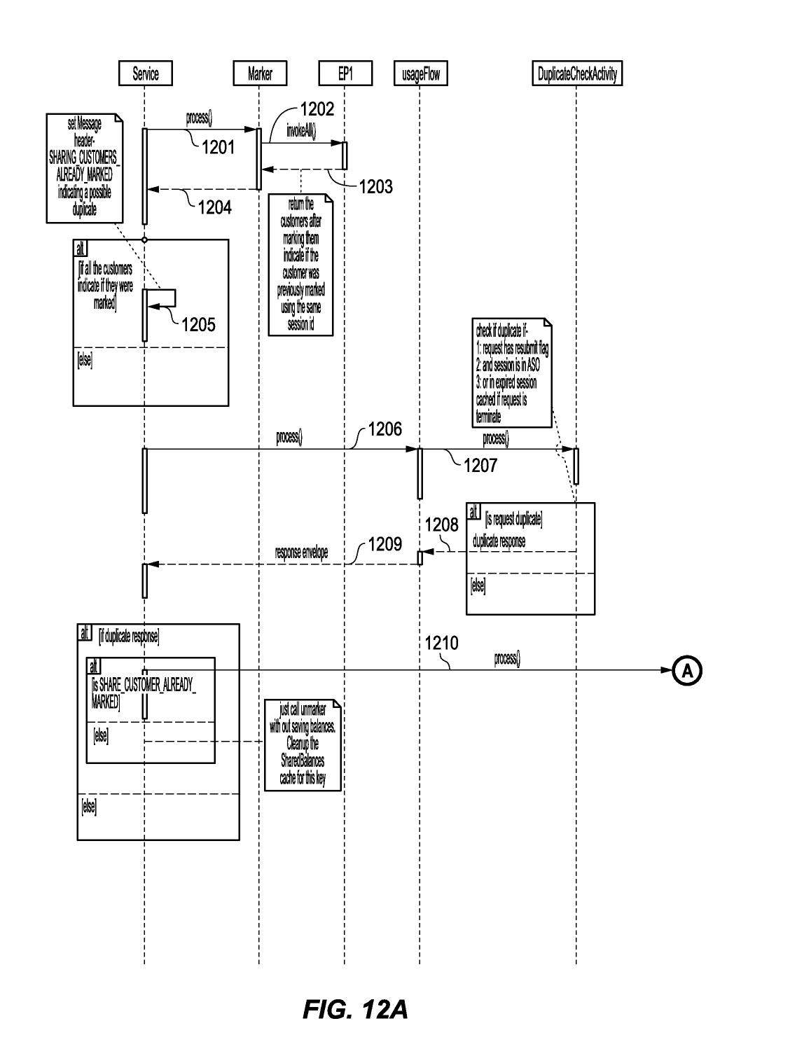

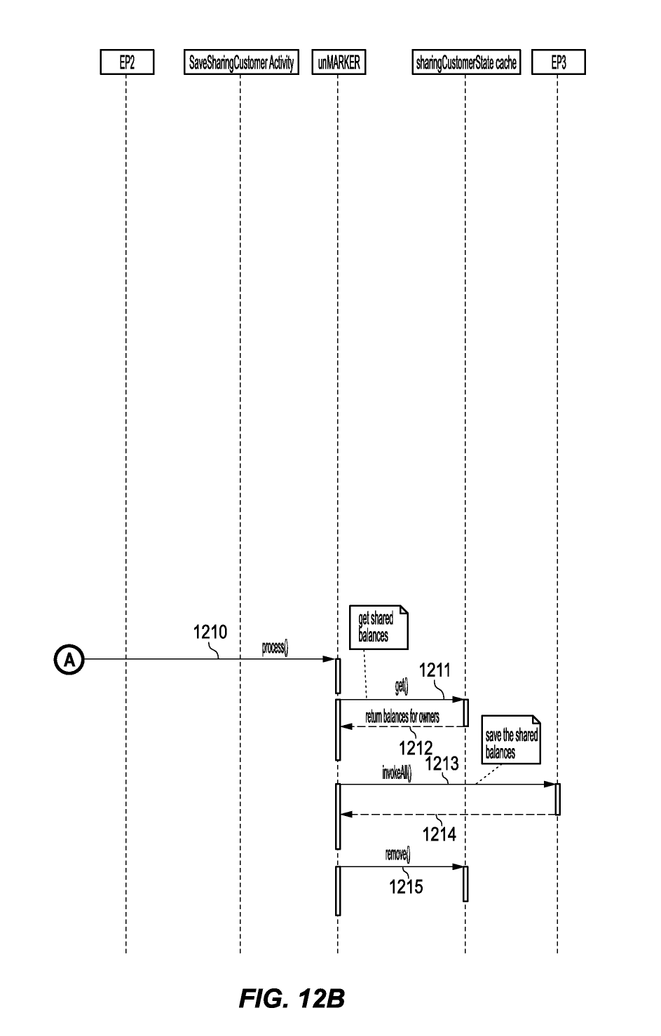

FIG. 12 is a simplified sequence diagram illustrating an example of a duplicate check transaction sequence, according to embodiments of the methods and systems disclosed herein. Using a duplicate check transaction sequence such as that depicted in FIG. 12, duplicate entries for shared customer services can be processed and removed. The processing of FIG. 12 begins with a local activity invocation making a determination as to whether the given subscribers are marked (1201) and, if unmarked, EP1 is invoked (1202), after which the appropriate responses are provided (1203 and 1204, which, after marking them, indicates whether one or more of the customers was previously marked using the same session identifier), unless one or more of the given subscribers are marked (1205) (e.g., if one or more of the customers are indicated as having been marked, and thus, the possibility of one or more duplicates). If the given subscribers are unmarked (1201), the local activity initiates a usage flow (1206), which, in turn, initiates a duplicate check activity (1207). The duplicate check activity responds, via the usage flow (1208 and 1209), at which point the duplicate check activity checks for duplicates by, for example, checking for:

1) Whether the request has its resubmit flag set and
a. The session is in ASO, or
b. The session is in the expired session cache if the request is a TERMINATE request

and responds accordingly. The local activity then initiates an unmarker (1210), which performs a get (1211) that returns the balances of the subscribers (1212). The unmarker then invokes EP3 (1213 and 1214), and removes then entry from the shared balances cache (1215). This results in the unmarker being called, without saving any balances, and the shared balances cached being cleaned up for this key.

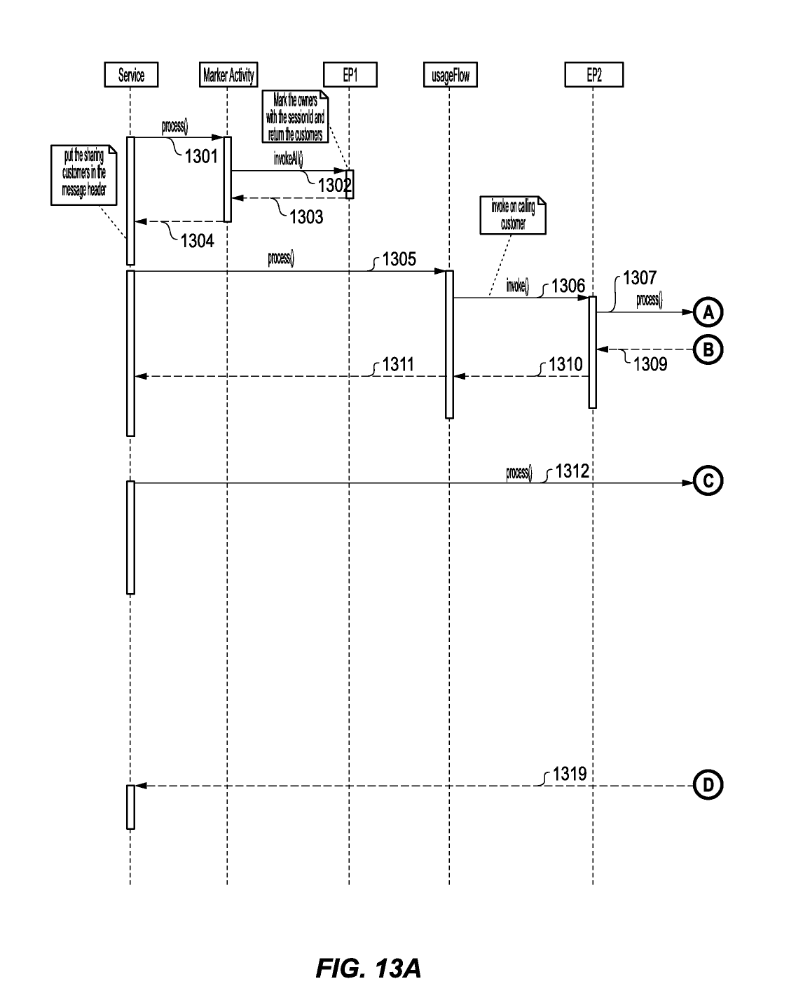

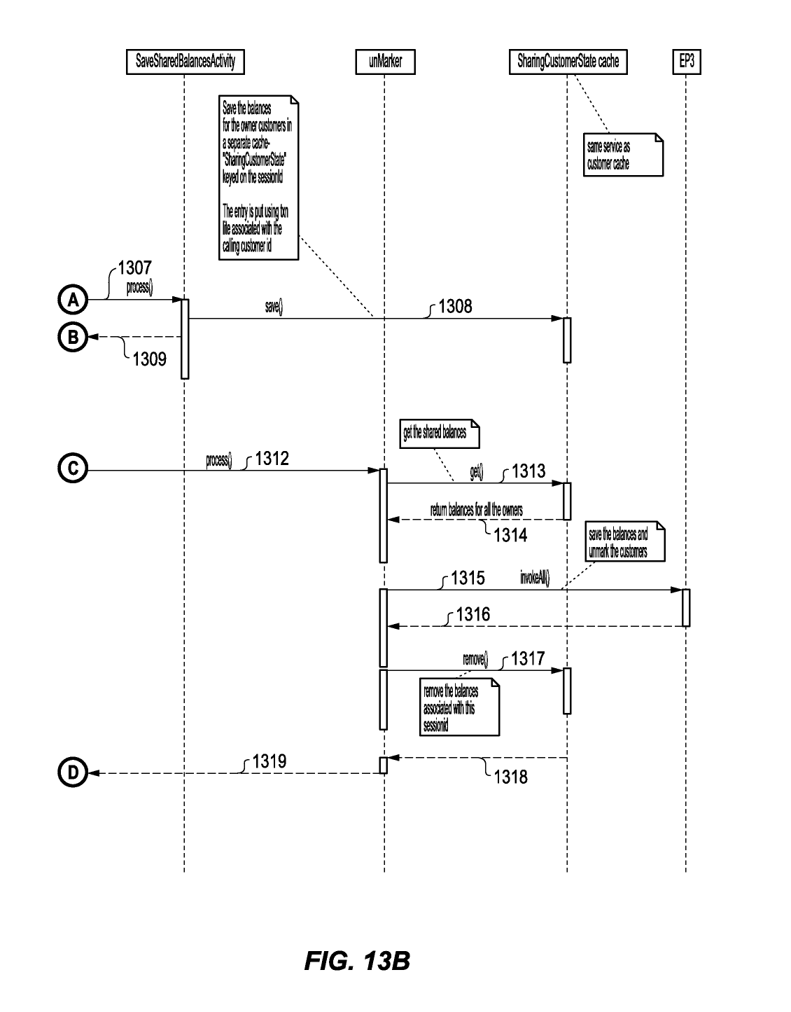

FIG. 13 is a simplified sequence diagram illustrating an example of another duplicate check transaction sequence, according to embodiments of the methods and systems disclosed herein. Using a duplicate check transaction sequence such as that depicted in FIG. 13, duplicate entries for shared customer services can be processed and removed. The processing of FIG. 13 begins with an RPC processing a request by processing a marker activity (1301). The marker activity, in turn, invokes an entry processor (EP1), which marks the owners with the session identifier and returns the customers, providing an appropriate response to the marker activity (1303), which, in turn, provides the appropriate response to the RPC (1304). If the given subscribers are unmarked (1301), the RPC initiates a usage flow (1305), which, in turn, invokes EP2 on the calling customer (1306). EP2 then invokes a save shared balances activity (1307), which, in turn, saves the balances in a shared balances cache (1308). In so doing, the save shared balances activity saves the balances for the owner customers in a separate cache (the shared balances cache), keyed on the session identifier. The entry is “put” using the local transaction that is associated with the calling customer (the calling customer's customer identifier).

The RPC then initiates an unmarker (1312), which obtains the requisite shared balance information from the shared balances cache (the shared customer state cache) (1313), which returns the balance information for the subscribers in question (1314). The unmarker then invokes EP3 (1315), in order to save the balance information for the affected owner customers (the subscribers) and unmark them (1316). The unmarker then causes the balances associated with the session, having been saved, to be deleted from the shared balances cache (1317 and 1318), and informs the RPC (1319).

### Example Operations in a Charging Environment Using a Five Entry Processor Approach

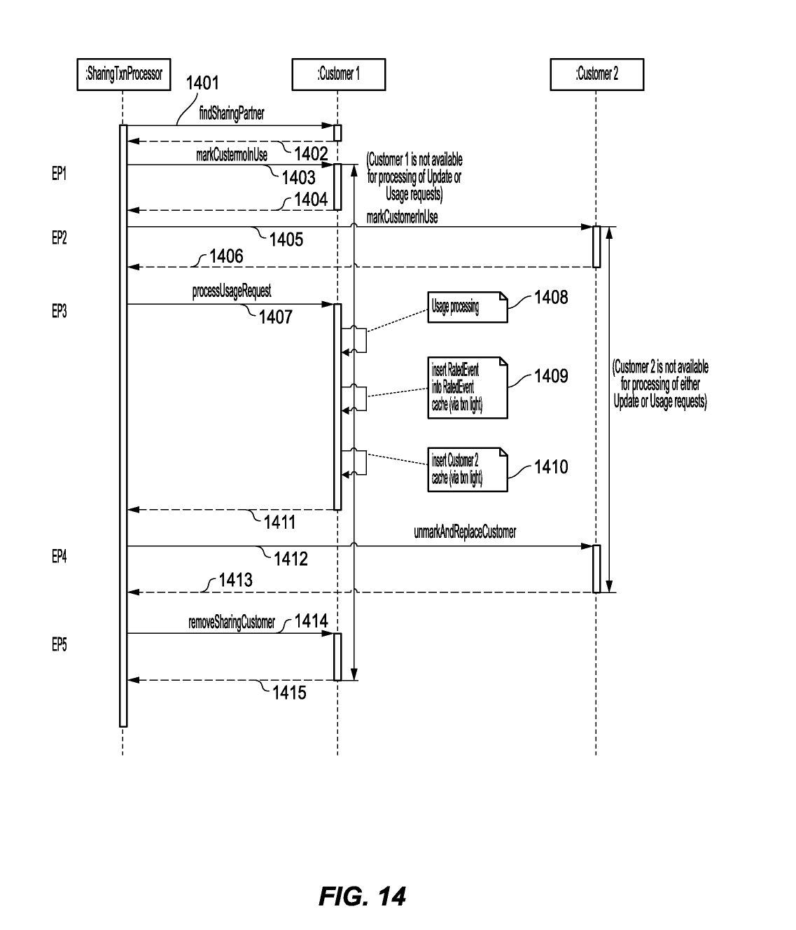

FIG. 14 is a simplified sequence diagram illustrating an example of a sharing transaction sequence, according to embodiments of the methods and systems disclosed herein, in which a five entry processor approach is described. Shown is a flow of the operations involved in a sharing with customer in a distributed cache and object processor (referred to in the following examples as an entry processor (EP)) that performs a local process. Such operations provide for eventual consistency. The operations depicted illustrate a single logical transaction that updates two different entries (one for each customer (subscriber) involved) residing in two different partitions (possibly across two different members (customers, or other manner of subscribers)) and inserts an event (also referred to herein as a rated event).

Such operations are depicted in FIG. 14. In response to a transaction request, a sharing transaction processor begins by performing operations, for example, to find a sharing partner (customer 1) (operations 1401 and 1402). The sharing transaction processor then marks (e.g., locks) the subscribers involved (customer 1 and customer 2) (operations 1403, 1404, 1405, and 1406). The sharing transaction processor then processes the usage request (operations 1407-1411). Having processed the usage request, the sharing transaction processor then unmarks (e.g., unlocks) the subscribers involved (customer 1 and customer 2) (operations 1412-1415).

As depicted in FIG. 14, such a logical transaction can be configured such that five entry processor (EP) physical transactions are involved. The characteristics of each entry processor is as follows:
EP1/EP2: Update and return Customer 1/2 (effectively lock Customer 1/2); Usage Request sent to Customer 1/2 will be suspended (similar to a mechanism likely required for ‘catch-up process’ for Re-Rating and Account Migration), if one of the accounts is already locked by another sharing transaction (typically, an infrequent occurrence). This entry processor is idempotent.
EP3: Execute core business logic, mark insert rated event and Customer 2 via transaction mechanism (key affinity). Customer 2 is only inserted temporarily in P1. This entry processor is not idempotent.
EP4: Replace Customer 2 with Customer 2′ and re-enable Customer 2 for general request processing. This entry processor is idempotent.
EP5: Remove Customer 2′ and re-enable Customer 1 for general request processing. This entry processor is idempotent.

Thus, as depicted in FIG. 14, a total of nine network roundtrip communications occur, originating from the node (sharing transaction processor) hosting P1:C1. Failure scenarios include logical transaction termination (because of a node failure or the like):
before EP1:
   P1:C1 unchanged
   P1:C2′ does not exist
   P1:RE does not exist
   P2:C2 unchanged
after EP1, before EP2:
   P1:C1 marked
   P1:C2′ does not exist
   P1:RE does not exist
   P2:C2 marked
after EP2, before EP3:
   P1:C1 marked
   P1:C2′ does not exist
   P1:RE does not exist
   P2:C2 marked
after EP3, before EP4:
   P1:C1 marked+changed
   P1:C2′ inserted
   P1:RE inserted
   P2:C2 marked
after EP4, before EP5:
   P1:C1 marked+changed
   P1:C2′ inserted
   P1:RE inserted
   P2:C2 changed
after EP5:
   P1:C1 changed
   P1:C2′ does not exist
   P1:RE inserted
   P2:C2 changed

Recovery algorithm:

```
C1.findSharingPartner -> C2
if (check C1 is marked == false)
then
  # C2 is marked again
  proceed with EP1, EP2, EP3, EP4, EP5
else
    # C2 is already marked
    if (C2′ exits != true)
    then
      proceed with EP3, EP4, EP5
    else
      proceed with EP4 (duplicate check: replace Customer
      only if marked), EP5
```

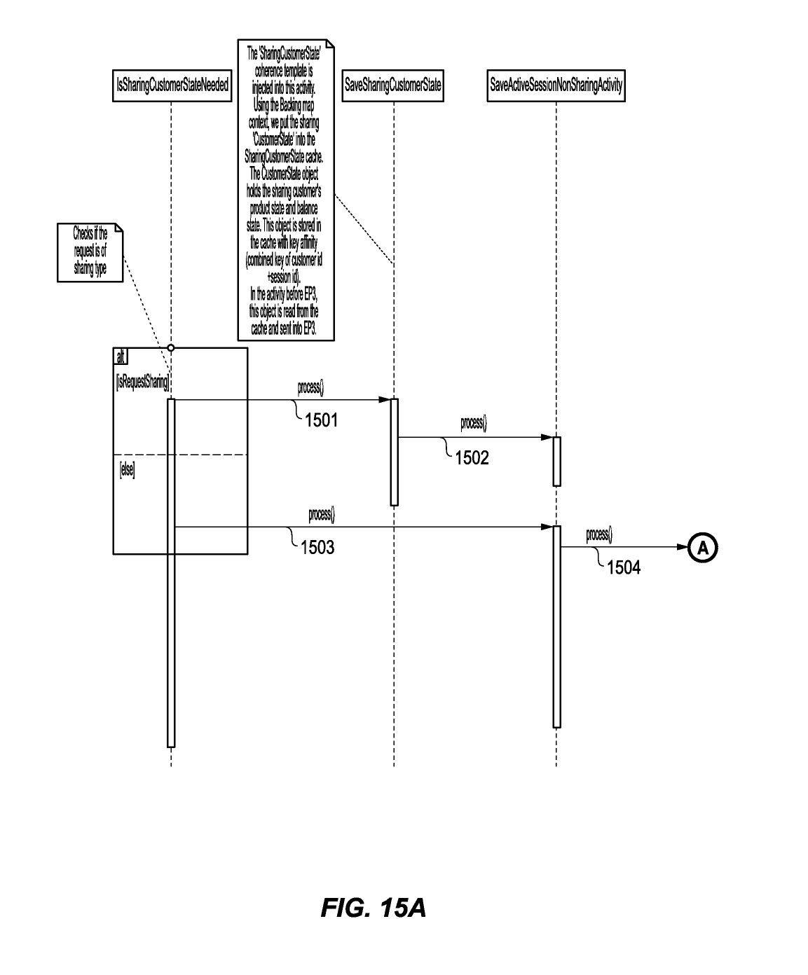

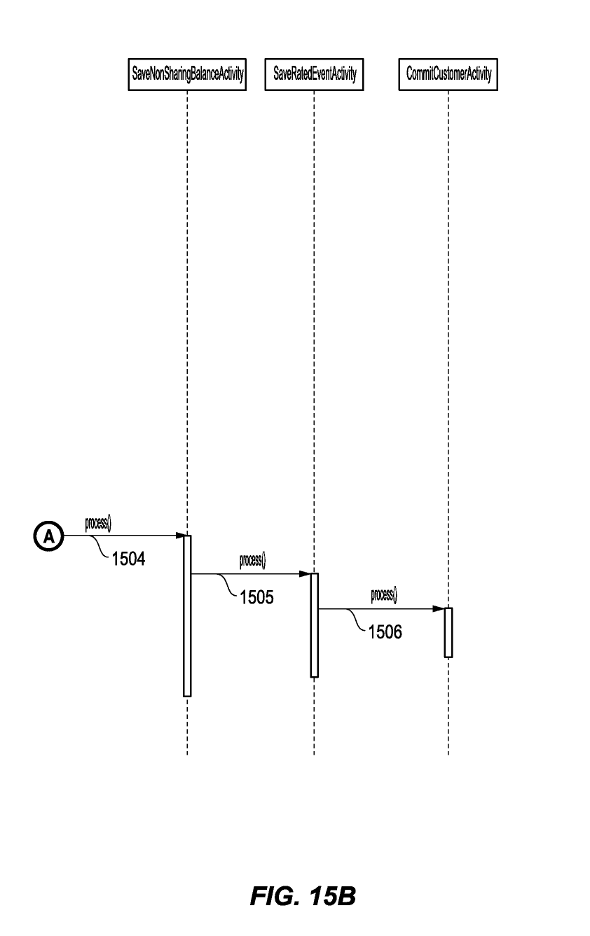

FIG. 15 is a simplified sequence diagram illustrating an example of a save sharing customer state activity transaction sequence, according to embodiments of the methods and systems disclosed herein, using the aforementioned five entry processor approach. The processing of FIG. 15 begins with a determination as to the type of request being made (i.e., a determination as to whether the request is of a sharing type) (1501). If the request being made is of a sharing type, save operation processed for the sharing customer state. This results in an operation that saves the active session sharing state, as well (1502). Otherwise, the request being made is not of a sharing type (i.e., is a non-sharing type of request), a non-sharing save operation of the session (a save active session for a non-sharing activity) is performed (1503). This results in the performance of a non-sharing balance activity (1504), which, in turn, results in the performance of a saved rated event activity (1505), and subsequently, a commit customer activity (1506).

### An Example Computing and Network Environment

As discussed above, the systems described herein can be implemented using a variety of computer systems and networks. Examples of such computing and network environments are described below with reference to FIGS. 16 and 17.

FIG. 16 depicts a block diagram of a computer system 1610 suitable for implementing aspects of the systems described herein, and the like. Computer system 1610 includes a bus 1612 which interconnects major subsystems of computer system 1610, such as a central processor 1614, a system memory 1617 (typically RAM, but which may also include ROM, flash RAM, or the like), an input/output controller 1618, an external audio device, such as a speaker system 1620 via an audio output interface 1622, an external device, such as a display screen 1624 via display adapter 1626, serial ports 1628 and 1630, a keyboard 1632 (interfaced with a keyboard controller 1633), a storage interface 1634, a floppy disk drive 1637 operative to receive a floppy disk 1638, a host bus adapter (HBA) interface card 1635A operative to connect with a Fibre Channel network 1690, a host bus adapter (HBA) interface card 1635B operative to connect to a SCSI bus 1639, and an optical disk drive 1640 operative to receive an optical disk 1642. Also included are a mouse 1646 (or other point-and-click device, coupled to bus 1612 via serial port 1628), a modem 1647 (coupled to bus 1612 via serial port 1630), and a network interface 1648 (coupled directly to bus 1612).

Bus 1612 allows data communication between central processor 1614 and system memory 1617, which may include read-only memory (ROM) or flash memory (neither shown), and random access memory (RAM) (not shown), as previously noted. RAM is generally the main memory into which the operating system and application programs are loaded. The ROM or flash memory can contain, among other code, the Basic Input-Output System (BIOS) which controls basic hardware operation such as the interaction with peripheral components. Applications resident with computer system 1610 are generally stored on and accessed from a computer-readable storage medium, such as a hard disk drive (e.g., fixed disk 1644), an optical drive (e.g., optical drive 1640), a floppy disk unit 1637, or other computer-readable storage medium.

Storage interface 1634, as with the other storage interfaces of computer system 1610, can connect to a standard computer-readable medium for storage and/or retrieval of information, such as a fixed disk drive 1644. Fixed disk drive 1644 may be a part of computer system 1610 or may be separate and accessed through other interface systems. Modem 1647 may provide a direct connection to a remote server via a telephone link or to the Internet via an internet service provider (ISP). Network interface 1648 may provide a direct connection to a remote server via a direct network link to the Internet via a POP (point of presence). Network interface 1648 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 16 need not be present to practice the systems described herein. The devices and subsystems can be interconnected in different ways from that shown in FIG. 16. The operation of a computer system such as that shown in FIG. 16 is readily known in the art and is not discussed in detail in this application. Code to implement the modules of the systems described herein can be stored in computer-readable storage media such as one or more of system memory 1617, fixed disk 1644, optical disk 1642, or floppy disk 1638. The operating system provided on computer system 1610 may be MS-WINDOWS®, UNIX®, Linux®, or other operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

Further, and as will be appreciated in light of the present disclosure, each of the operations described herein may be executed by a module (e.g., a software module) or a portion of a module, or a computer system user. Thus, the above-described method, the operations thereof and modules therefor may be executed on a computer system configured to execute the operations of the method and/or may be executed from computer-readable storage media. The method may be embodied in a machine-readable and/or computer-readable storage medium for configuring a computer system to execute the method. Thus, the software modules may be stored within and/or transmitted to a computer system memory to configure the computer system to perform the functions of the module.

The software modules described herein may be received by a computer system, for example, from computer-readable storage media. Such computer readable storage media may be permanently, removably or remotely coupled to the computer system. Computer-readable storage media may non-exclusively include, for example, any number of the following: magnetic storage media (including disk and tape storage media); optical storage media such as compact disk media (e.g., CD ROM, CD R, etc.) and digital video disk storage media; nonvolatile memory storage memory including semiconductor-based memory units such as FLASH memory, EEPROM, EPROM, ROM or application specific integrated circuits; and volatile storage media (including registers, buffers or caches, main memory, RAM, etc.). In a UNIX-based embodiment, the software modules may be embodied in a file, which may be a device, a terminal, a local or remote file, a socket, or other such element. Other new and various types of computer-readable storage media may also be used to store the software modules discussed herein.

Many other devices or subsystems (not shown) may be connected in a similar manner (e.g., bar code readers, document scanners, digital cameras and so on). Conversely, it is not necessary for all of the devices shown in FIG. 16 to be present to practice the present invention. The devices and subsystems may be interconnected in different ways from that shown in FIG. 16. The operation of a computer system such as that shown in FIG. 16 is readily known in the art and is not discussed in detail in this application. Code to implement the present invention may be stored in computer-readable storage media such as one or more of system memory 1616, fixed disk 1644, CD-ROM 1642, or floppy disk 1638. Additionally, computer system 1610 may be any kind of computing device, and so includes personal data assistants (PDAs), network appliance, X-window terminal or other such computing device. The operating system provided on computer system 1610 may be MS-DOS®, MS-WINDOWS®, UNIX®, Linux® or other known operating system. Computer system 1610 also supports a number of Internet access tools, including, for example, an HTTP-compliant web browser having a JavaScript interpreter, such as Netscape Navigator®, Microsoft Internet Explorer® and the like.

Moreover, regarding the signals described herein, those skilled in the art will recognize that a signal may be directly transmitted from a first block to a second block, or a signal may be modified (e.g., amplified, attenuated, delayed, latched, buffered, inverted, filtered or otherwise modified) between the blocks. Although the signals of the above described embodiment are characterized as transmitted from one block to the next, other embodiments of the present invention may include modified signals in place of such directly transmitted signals as long as the informational and/or functional aspect of the signal is transmitted between blocks. To some extent, a signal input at a second block may be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

FIG. 17 is a block diagram depicting a network architecture 1700 in which client systems 1710, 1720 and 1730, as well as storage servers 1740A and 1740B (any of which can be implemented using computer system 1710), are coupled to a network 1750. Storage server 1740A is further depicted as having storage devices 1760A(1)-(N) directly attached, and storage server 1740B is depicted with storage devices 1760B(1)-(N) directly attached. Storage servers 1740A and 1740B are also connected to a SAN fabric 1770, although connection to a storage area network is not required for operation. SAN fabric 1770 supports access to storage devices 1780(1)-(N) by storage servers 1740A and 1740B, and so by client systems 1710, 1720 and 1730 via network 1750. Intelligent storage array 1790 is also shown as an example of a specific storage device accessible via SAN fabric 1770.

With reference to computer system 1610, modem 1647, network interface 1648 or some other method can be used to provide connectivity from each of client computer systems 1710, 1720 and 1730 to network 1750. Client systems 1710, 1720 and 1730 are able to access information on storage server 1740A or 1740B using, for example, a web browser or other client software (not shown). Such a client allows client systems 1710, 1720 and 1730 to access data hosted by storage server 1740A or 1740B or one of storage devices 1760A(1)-(N), 1760B(1)-(N), 1780(1)-(N) or intelligent storage array 1790. FIG. 18 depicts the use of a network such as the Internet for exchanging data, but the systems described herein are not limited to the Internet or any particular network-based environment.

The foregoing described embodiments wherein the different components are contained within different other components (e.g., the various elements shown as components of computer system 1610, discussed subsequently). It is to be understood that such depicted architectures are merely examples, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality.

### Other Embodiments

The systems described herein are well adapted to attain the advantages mentioned as well as others inherent therein. While such systems have been depicted, described, and are defined by reference to particular descriptions, such references do not imply a limitation on the claims, and no such limitation is to be inferred. The systems described herein are capable of considerable modification, alteration, and equivalents in form and function, as will occur to those ordinarily skilled in the pertinent arts in considering the present disclosure. The depicted and described embodiments are examples only, and are in no way exhaustive of the scope of the claims.

The foregoing detailed description has set forth various embodiments of the systems described herein via the use of block diagrams, flowcharts, and examples. It will be understood by those within the art that each block diagram component, flowchart operation, operation and/or component illustrated by the use of examples can be implemented (individually and/or collectively) by a wide range of hardware, software, firmware, or any combination thereof.

The systems described herein have been described in the context of fully functional computer systems; however, those skilled in the art will appreciate that the systems described herein are capable of being distributed as a program product in a variety of forms, and that the systems described herein apply equally regardless of the particular type of computer-readable media used to actually carry out the distribution. Examples of computer-readable media include computer-readable storage media, as well as media storage and distribution systems developed in the future.

The above-discussed embodiments can be implemented by software modules that perform one or more tasks associated with the embodiments. The software modules discussed herein may include script, batch, or other executable files. The software modules may be stored on a machine-readable or computer-readable storage media such as magnetic floppy disks, hard disks, semiconductor memory (e.g., RAM, ROM, and flash-type media), optical discs (e.g., CD-ROMs, CD-Rs, and DVDs), or other types of memory modules. A storage device used for storing firmware or hardware modules in accordance with an embodiment can also include a semiconductor-based memory, which may be permanently, removably or remotely coupled to a microprocessor/memory system. Thus, the modules can be stored within a computer system memory to configure the computer system to perform the functions of the module. Other new and various types of computer-readable storage media may be used to store the modules discussed herein.

The above description is intended to be illustrative and should not be taken to be limiting. As will be appreciated in light of the present disclosure, other embodiments are possible. Those skilled in the art will readily implement the operations necessary to provide the structures and the methods disclosed herein, and will understand that the process parameters and sequence of operations are given by way of example only and can be varied to achieve the desired structure as well as modifications that are within the scope of the claims. Variations and modifications of the embodiments disclosed herein can be made based on the description set forth herein, without departing from the scope of the claims, giving full cognizance to equivalents thereto in all respects.

Although the systems described herein have been described in connection with several embodiments, these embodiments and their descriptions are not intended to be limited to the specific forms set forth herein. On the contrary, it is intended that such embodiments address such alternatives, modifications, and equivalents as can be reasonably included within the scope of the appended claims.

What is claimed is:

1. A method comprising:
executing a transaction on a plurality of distributed objects, wherein
the plurality of distributed objects are maintained on a plurality of computing entities,
a distributed relationship exists between the plurality of objects, and
the executing comprises
performing a preparation operation,
performing a processing operation, and
performing a post-processing operation.

2. The method of claim 1, wherein the preparation operation comprises:
reserving first data of a first object and second data of a second object, wherein
the reserving results in a reservation against the first data and the second data,
the plurality of objects comprises the first object and the second object,
the first object is maintained on a first computing entity, and
the second object is maintained on a second computing entity.

3. The method of claim 2, wherein the preparation operation further comprises:
making a copy of the second data; and
transporting the copy of the second data from the second computing entity to the first computing entity.

4. The method of claim 2, wherein the processing operation comprises:
performing usage processing, wherein
the usage processing uses the first data and the second data; and
determining a result of the usage processing.

5. The method of claim 4, wherein the post-processing operation comprises:
applying the result of the usage processing to the first object and the second object.

6. The method of claim 5, wherein the post-processing operation further comprises:
releasing the reservation.

7. The method of claim 1, wherein
the plurality of distributed objects are a plurality of subscriber objects,
a first subscriber object of the subscriber objects is associated with a primary subscriber of a plurality of subscribers,
a second subscriber object of the subscriber objects is associated with a secondary subscriber of the plurality of subscribers,
the first subscriber object comprises first subscriber data, and
the second subscriber object comprises second subscriber data.

8. The method of claim 7, wherein
the distributed relationship is a sharing relationship, and
the primary subscriber and the secondary subscriber are in the sharing relationship.

9. The method of claim 7, wherein the preparation operation comprises:
reserving the first subscriber data and the second subscriber data, wherein
the reserving results in a reservation against the first subscriber data and the second subscriber data,
the first subscriber object is maintained in a first partition, and
the second subscriber object is maintained in a second partition.

10. The method of claim 9, wherein the preparation operation comprises:
making a copy of the second subscriber data; and
transporting the copy of the second subscriber data from the second partition to the first partition.

11. The method of claim 9, wherein the preparation operation comprises:
performing usage processing, wherein
the usage processing uses the first subscriber data and the second subscriber data; and
determining a change set resulting from the usage processing.

12. The method of claim 11, wherein the post-processing operation comprises:
applying the change set to the first subscriber object; and
applying the change set to the second subscriber object.

13. The method of claim 12, wherein the post-processing operation further comprises:
releasing the reservation.

14. The method of claim 12, wherein the post-processing operation further comprises:
deleting the change set.

15. A computer program product comprising:
a plurality of instructions, comprising
a first set of instructions, executable on a computer system, configured to execute a transaction on a plurality of distributed objects, wherein
the plurality of distributed objects are maintained on a plurality of computing entities,
a distributed relationship exists between the plurality of objects, and
the first set of instructions comprises
a first subset of instructions, executable on the computer system, configured to perform a preparation operation,
a second subset of instructions, executable on the computer system, configured to perform a processing operation, and
a third subset of instructions, executable on the computer system, configured to perform a post-processing operation; and
a computer-readable storage medium, wherein the instructions are encoded in the computer-readable storage medium.

16. The computer program product of claim 15, wherein the first subset of instructions comprise:
a first sub-subset of instructions, executable on the computer system, configured to reserve first data of a first object and second data of a second object, wherein
execution of the first sub-subset of instructions results in a reservation against the first data and the second data,
the plurality of objects comprises the first object and the second object,
the first object is maintained on a first computing entity, and
the second object is maintained on a second computing entity;
a second sub-subset of instructions, executable on the computer system, configured to make a copy of the second data; and
a third sub-subset of instructions, executable on the computer system, configured to transport the copy of the second data from the second computing entity to the first computing entity.

17. The computer program product of claim 16, wherein the second subset of instructions comprise:
a fourth sub-subset of instructions, executable on the computer system, configured to perform usage processing, wherein
the usage processing uses the first data and the second data;
a fifth sub-subset of instructions, executable on the computer system, configured to determine a result of the usage processing;
a sixth sub-subset of instructions, executable on the computer system, configured to apply the result of the usage processing to the first object and the second object; and
a seventh sub-subset of instructions, executable on the computer system, configured to release the reservation.

18. The computer program product of claim 15, wherein
the plurality of distributed objects are a plurality of subscriber objects,
a first subscriber object of the subscriber objects is associated with a primary subscriber of a plurality of subscribers,
a second subscriber object of the subscriber objects is associated with a secondary subscriber of the plurality of subscribers,
the first subscriber object comprises first subscriber data,
the second subscriber object comprises second subscriber data, wherein
the distributed relationship is a sharing relationship, and
the primary subscriber and the secondary subscriber are in the sharing relationship.

19. The computer program product of claim 18, wherein the second subset of instructions comprises:
a first sub-subset of instructions, executable on the computer system, configured to reserve the first subscriber data and the second subscriber data, wherein
execution of the first sub-subset of instructions results in a reservation against the first subscriber data and the second subscriber data,
the first subscriber object is maintained in a first partition,
the second subscriber object is maintained in a second partition
a second sub-subset of instructions, executable on the computer system, configured to make a copy of the second subscriber data;
a third sub-subset of instructions, executable on the computer system, configured to transport the copy of the second subscriber data from the second partition to the first partition;
a fourth sub-subset of instructions, executable on the computer system, configured to perform usage processing, wherein
the usage processing uses the first subscriber data and the second subscriber data; and
a fifth sub-subset of instructions, executable on the computer system, configured to determine a change set resulting from the usage processing.

20. A computer system comprising:
one or more processors;
a computer-readable storage medium coupled to the processor; and
a plurality of instructions, encoded in the computer-readable storage medium and configured to cause the processor to
execute a transaction on a plurality of distributed objects, wherein
the plurality of distributed objects are maintained on a plurality of computing entities,
a distributed relationship exists between the plurality of objects, and
the instructions configured to cause the processor to execute comprise instructions configured to
perform a preparation operation,
perform a processing operation, and
perform a post-processing operation.
